(19) United States
(12) Patent Application Publication
(10) Pub. No.: US 2026/0221528 A1
(43) Pub. Date: Jul. 30, 2026

(54) WIRELESS DEVICE AND POWER SUPPLY UNIT

(71) Applicant: DENSO CORPORATION, Kariya-city (JP)

(72) Inventors: Yuto HONDA, Kariya-city (JP); Tatsuhiro NUMATA, Kariya-city (JP)

(73) Assignee: DENSO CORPORATION, Kariya-city (JP)

(21) Appl. No.: 19/573,586

(22) Filed: Mar. 20, 2026

Related U.S. Application Data
(63) Continuation of application No. PCT/JP2024/030906, filed on Aug. 29, 2024.

(30) Foreign Application Priority Data
Sep. 21, 2023 (JP) 2023-155801

(51) Int. Cl. H01M 10/42; H01M 10/48; H01Q 9/04

(52) U.S. Cl. CPC H01M 10/425; H01M 10/48; H01Q 9/0407; H01M 2010/4278

(57) ABSTRACT

A wireless device of a battery monitoring system includes a wireless antenna and a proximate conductor that overlaps at least a portion of a projection plane of the wireless antenna in a predefined projection direction.

### CROSS-REFERENCE TO RELATED APPLICATION

This application is a continuation application of International Application No. PCT/JP2024/030906 filed August 29, 2024 which designated the U.S. and claims priority to Japanese Patent Application No. 2023-155801 filed September 21, 2023, the contents of each of which are incorporated herein by reference.

### BACKGROUND

### Technical Field

The present disclosure relates to a wireless device and a power supply unit for a battery monitoring system.

### Related Art

In recent years, a battery monitoring system that transmits or receives a battery state of a battery cell through wireless communication has been known.

### BRIEF DESCRIPTION OF THE DRAWINGS

In the accompanying drawings:

FIG. 1 is a schematic diagram of an overall configuration of a vehicle;

FIG. 2 is a block diagram illustrating a configuration of a battery pack;

FIG. 3 is a diagram illustrating an interior of the battery pack;

FIG. 4 is a perspective view of a storage case;

FIG. 5 is a side cross-sectional view illustrating an interior of a battery monitoring device;

FIG. 6 is a diagram illustrating a configuration of a slave-side wireless antenna;

FIG. 7 is a diagram illustrating a projected surface of the slave-side wireless antenna;

FIGS. 8A and 8B are diagrams schematically illustrating a change in capacitance in a comparative example;

FIGS. 9A and 9B are diagrams schematically illustrating a change in capacitance in a first embodiment;

FIG. 10 is a side view illustrating an interior of a battery monitoring device in a modification;

FIG. 11 is a perspective view illustrating the battery monitoring device in a modification;

FIG. 12 is a perspective view illustrating an element in a modification;

FIGS. 13A and 13B are perspective views illustrating a ground plate in a modification;

FIG. 14 is a perspective view illustrating a slave-side wireless antenna in a modification;

FIGS. 15A and 15B are diagrams illustrating a metal plate in a modification;

FIG. 16 is a top view illustrating an interior of a battery pack in a second embodiment;

FIG. 17 is a side view illustrating the interior of the battery pack in the second embodiment;

FIG. 18 is a perspective view illustrating an ECU case in the second embodiment;

FIG. 19 is a top view illustrating an interior of a battery pack in a modification;

FIG. 20A is a top view of an interior of a battery pack in a modification;

FIG. 20B is a side view of the interior of the battery pack in the modification;

FIG. 21A is a top view of an interior of a battery pack in a modification;

FIG. 21B is a side view of the interior of the battery pack in the modification;

FIG. 22A is a top view of an interior of a battery pack in a modification;

FIG. 22B is a side view of the interior of the battery pack in the modification;

FIG. 23A is a side view of an interior of a battery pack in a modification;

FIG. 23B is a side view of the interior of the battery pack in the modification;

FIG. 24 is a top view illustrating an interior of a battery pack in a modification;

FIG. 25 is a top view illustrating an interior of a battery pack in a modification;

FIG. 26A is a top view illustrating an interior of a battery pack in a modification;

FIG. 26B is a perspective view illustrating a protruding portion in a modification;

FIG. 27 is a top view illustrating an interior of a battery pack in a modification;

FIG. 28 is a top view illustrating an interior of a battery pack in a modification;

FIG. 29A is a diagram illustrating an electromagnetic shield in a modification;

FIG. 29B is a diagram illustrating an electromagnetic shield in a modification;

FIG. 30 is a top view illustrating an interior of a battery pack in a third embodiment;

FIG. 31A is a side view of the interior of the battery pack in the third embodiment;

FIG. 31B is a top view of an interior of a battery pack in a modification;

FIG. 32 is a top view illustrating an interior of a battery pack in a modification;

FIG. 33 is a cross-sectional view illustrating an interior of a battery pack in a modification; and

FIG. 34 is a perspective view illustrating a battery block in a modification.

### DESCRIPTION OF SPECIFIC EMBODIMENTS

For a wireless device of a battery monitoring system (as disclosed in US2017301961 A1), it is preferable to design the wireless device such that antenna characteristics are maintained at appropriate values under any environment.

In view of the foregoing, it is desired to have a wireless device and a power supply unit capable of maintaining antenna characteristics at appropriate values.

A means for solving the above problem provides a wireless device for a battery monitoring system. The wireless device includes a wireless antenna and a proximate conductor that overlaps at least a part of a projected surface of the wireless antenna when a predefined direction is defined as a projection direction.

The proximate conductor causes electrostatic coupling with the wireless antenna and generates capacitance therebetween. If the capacitance is large, even when floating capacitance occurs between the wireless antenna and another conductor, the proportion of the capacitance between the proximate conductor and the wireless antenna increases. Accordingly, the proportion of the floating capacitance, that is, a variation amount, relative to the original capacitance becomes relatively small. This can suppress the influence on the antenna characteristics even when a surrounding environment changes.

Hereinafter, some embodiments will be described with reference to the accompanying drawings. In each of the embodiments described below, identical reference numerals are used to designate identical elements that are common to the elements described in the preceding embodiments. Duplicated description thereof will be omitted. The following description illustrates an example in which the configuration is applied to a vehicle. The configuration is also applicable to other than vehicles, for example, flying bodies such as drones, ships, construction machines, and agricultural machines.

### First Embodiment

### Vehicle

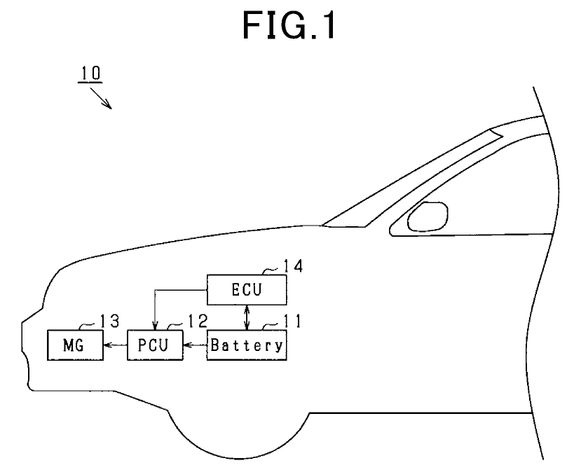

FIG. 1 is a diagram schematically illustrating a configuration of a vehicle 10. The vehicle 10 is an electric vehicle such as an electric vehicle (EV), a hybrid vehicle (HV), or a plug-in hybrid vehicle (PHV). The vehicle 10 includes a battery pack 11 (indicated as Battery in FIG. 1), a power control unit 12 as a power conversion device (hereinafter referred to as PCU), a motor 13 as an electric load (indicated as MG in FIG. 1), and a vehicle ECU 14 (indicated as ECU in FIG. 1). PCU is an abbreviation for Power Control Unit, MG is an abbreviation for Motor Generator, and ECU is an abbreviation for Electronic Control Unit.

The battery pack 11 is mounted to the vehicle 10 as a power supply unit (drive power source) of the vehicle 10. In FIG. 1, the battery pack 11 is disposed, for example, in a front compartment. The battery pack 11 may be disposed in a rear compartment, under a seat, or under a floor.

The battery pack 11 includes an assembled battery 20 described later and serves as a chargeable and dischargeable DC voltage source. The battery pack 11 supplies electric power to an electric load of the vehicle 10. The battery pack 11 converts electric power through the PCU 12 and supplies the electric power to the motor 13. The battery pack 11 is charged through the PCU 12.

The PCU 12 performs bidirectional power conversion between the battery pack 11 and the motor 13 in accordance with a control signal from the vehicle ECU 14. The PCU 12 includes, for example, an inverter that converts a DC voltage from the battery pack 11 into an AC voltage to drive the motor 13, and a converter that steps up the DC voltage supplied to the inverter to a voltage equal to or higher than an output voltage of the battery pack 11.

The motor 13 is an AC rotating electric machine and is, for example, a three-phase AC synchronous motor having permanent magnets embedded in a rotor. The PCU 12 drives the motor 13 to generate rotational drive force, and the generated drive force is transmitted to drive wheels. During braking of the vehicle 10, the motor 13 operates as a generator and performs regenerative power generation. Electric power generated by the motor 13 is supplied to the battery pack 11 through the PCU 12 and stored in the assembled battery 20.

The vehicle ECU 14 includes a CPU, a ROM, a RAM, and input/output ports for inputting and outputting various signals. The CPU loads a program stored in the ROM into the RAM and executes the program. The program stored in the ROM describes processing executed by the vehicle ECU 14. As one example of main processing performed by the vehicle ECU 14, the vehicle ECU 14 receives information such as a voltage, a current, a state of charge (SOC), and a state of health (SOH) of the assembled battery 20 from the battery pack 11, and controls the PCU 12 to command driving of the motor 13 and charging and discharging of the battery pack 11.

### Battery Pack

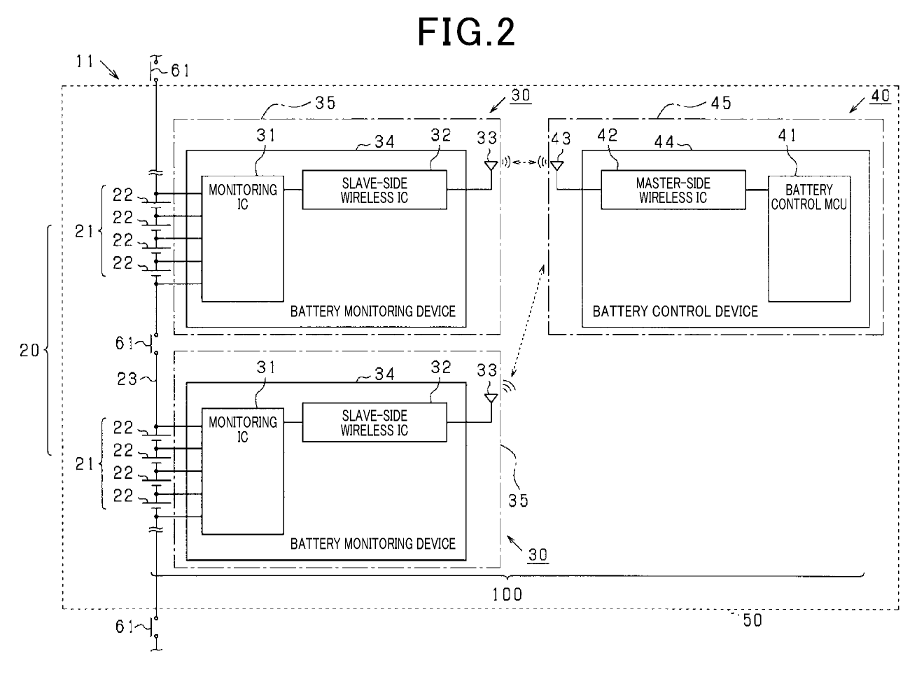

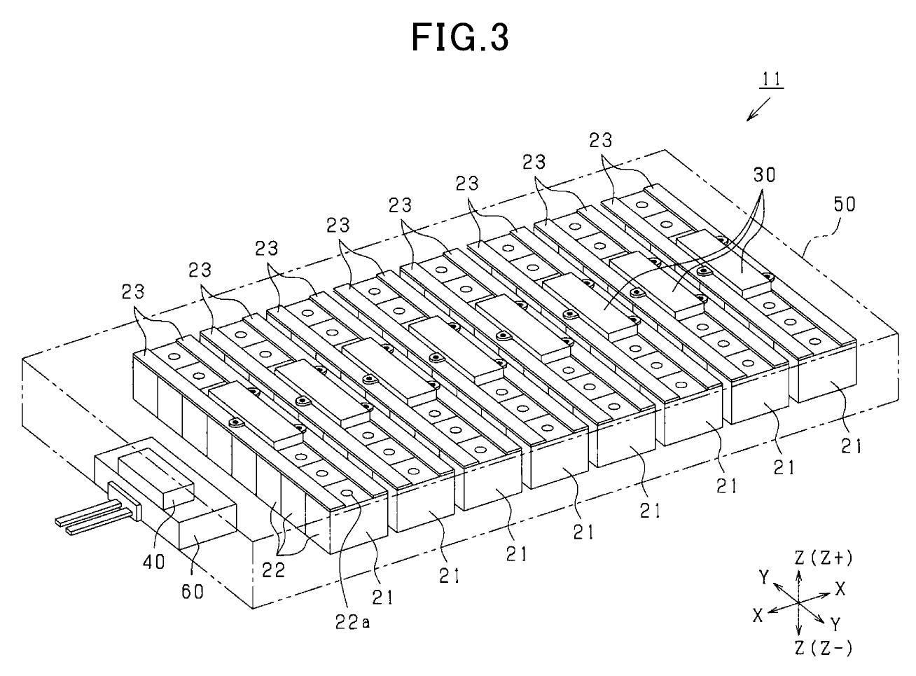

The battery pack 11 will now be described in detail. FIG. 2 is a block diagram illustrating a configuration of the battery pack 11, and FIG. 3 is a plan view schematically illustrating arrangement of various elements accommodated in the battery pack 11. The battery pack 11 includes the assembled battery 20, a junction box 60, a battery monitoring system 100, and a storage case 50 (indicated by a dashed line) that accommodates these components. The battery monitoring system 100 monitors and manages a battery state of the assembled battery 20 using wireless communication. The battery monitoring system 100 includes a plurality of battery monitoring devices 30 and a battery control device 40, and wireless communication is performed therebetween. Each of the battery monitoring devices 30 and the battery control device 40 corresponds to a wireless device.

In the present embodiment, the assembled battery 20, the battery monitoring devices 30, and the battery control device 40 are accommodated inside the storage case 50 (battery accommodation space), but may be disposed outside the storage case 50. Alternatively, the storage case 50 may be omitted, and the assembled battery 20 and the battery monitoring system 100 may be directly attached to a battery accommodation space provided in a vehicle body frame. That is, the vehicle body frame may serve as the storage case 50.

### Assembled Battery

The assembled battery 20 includes a plurality of battery blocks 21. The assembled battery 20 is configured by connecting the plurality of battery blocks 21 in series and/or in parallel. Each battery block 21 includes a plurality of battery cells 22. Each battery cell 22 may be a rechargeable lithium-ion battery, a nickel-hydrogen rechargeable battery, or the like. The rechargeable lithium-ion battery is a secondary battery that uses lithium as a charge carrier and may include not only a typical rechargeable lithium-ion battery having a liquid electrolyte but also a so-called all-solid-state battery using a solid electrolyte. The battery block 21 is configured by connecting the plurality of battery cells 22 in series and/or in parallel via bus bars 23. Provision of the battery block 21 is optional, and the assembled battery 20 may be configured by connecting a plurality of battery cells 22 in series and/or in parallel. In the present embodiment, the assembled battery 20, the battery block 21, and the battery cell 22 correspond to a battery unit.

Each battery cell 22 is provided with a cell explosion-proof valve 22a (safety valve) that releases internal gas when a pressure difference between an inside and an outside of a battery case exceeds a predefined value. In the first embodiment, the cell explosion-proof valve 22a is provided at an arbitrary location and, for example, is provided on the upper surface of the battery cell 22 in FIG. 3.

### Junction Box

The junction box 60 accommodates one or more relay switches 61 and the like. As illustrated in FIG. 2, the relay switch 61 connects the battery blocks 21 (or the battery cells 22) in series and/or in parallel. The relay switch 61 switches between an energized state and a de-energized state in the assembled battery 20 to allow the battery pack 11 to be charged and discharged. The battery control device 40 or the like controls ON/OFF states of the relay switches 61.

### Battery Monitoring Device

The battery monitoring device 30 will now be described. Configurations of the respective battery monitoring devices 30 are common to each other. The battery monitoring device 30, also referred to as a satellite battery module (SBM), is provided for each battery block 21 corresponding to a plurality of battery cells 22. As illustrated in FIG. 2, each battery monitoring device 30 includes a monitoring IC 31, a slave-side wireless IC 32, a slave-side wireless antenna 33, and the like. These components are mounted on a monitoring circuit board 34 of the battery monitoring device 30 and are accommodated and fixed in an SBM case 35 serving as a housing of the battery monitoring device 30 (indicated by a dashed-dotted line in FIG. 2).

The slave-side wireless IC 32 is connected in a wired manner to the monitoring IC 31. The slave-side wireless IC 32 is connected in a wired manner to the slave-side wireless antenna 33.

The monitoring IC 31 is also referred to as a cell monitoring circuit and acquires battery information of each battery cell 22 constituting the battery block 21 via a physical-quantity detection sensor (not illustrated). The physical-quantity detection sensor includes, for example, a voltage sensor, a temperature sensor, and a current sensor. The battery information includes voltage information, temperature information, and current information for each battery cell 22. The monitoring target of the battery monitoring device 30 may be the battery block 21 or the entire assembled battery 20. The monitoring target may be changed as appropriate.

Upon receiving data requesting acquisition and transmission of battery information (control data as control information), the monitoring IC 31 acquires the battery information according to the control data and transmits monitoring data (control result) including at least the battery information. The monitoring IC 31 may execute failure diagnosis (self-diagnosis) of circuit portions of the battery monitoring device 30 including itself and may transmit the monitoring data including a diagnosis result together with the acquired battery information.

The slave-side wireless IC 32 includes an RF circuit (not illustrated), a microcomputer, a front-end circuit, and the like to wirelessly transmit and receive data. The slave-side wireless IC 32 has a transmission function of modulating data and oscillating at a frequency of an RF signal. The slave-side wireless IC 32 has a reception function of demodulating received data. RF is an abbreviation for radio frequency.

The slave-side wireless IC 32 modulates monitoring data including battery information received from the monitoring IC 31 and transmits the modulated monitoring data to the battery control device 40 via the slave-side wireless antenna 33. At that time, the slave-side wireless IC 32 adds data necessary for wireless communication, such as communication control information, to the monitoring data including the battery information and transmits the resulting data. The data necessary for wireless communication include, for example, an identifier (ID) and an error detection code. The slave-side wireless IC 32 has functions of determining a data size, a communication format, and a schedule of communication between the battery monitoring device 30 and the battery control device 40 and detecting an error.

The slave-side wireless IC 32 receives data wirelessly transmitted from the battery control device 40 via the slave-side wireless antenna 33 and demodulates the received data. Upon receiving control data including, for example, a request for acquisition and transmission of battery information, the slave-side wireless IC 32 transmits the control data to the monitoring IC 31 via a wired connection. Upon receiving monitoring data including the battery information from the monitoring IC 31 as a response to the request, the slave-side wireless IC 32 modulates response data including the monitoring data and wirelessly transmits the modulated response data to the battery control device 40 via the slave-side wireless antenna 33.

The slave-side wireless antenna 33 converts an RF signal, which is an electric signal, into a radio wave and radiates the radio wave into space, and receives a radio wave propagating through space and converts the received radio wave into an electric signal.

### Battery Control Device

The battery control device 40 is also referred to as a battery ECU or a battery management unit (BMU). The battery control device 40 is configured to be capable of wireless communication with each battery monitoring device 30.

Specifically, as illustrated in FIG. 2, the battery control device 40 includes a battery control MCU 41, a master-side wireless IC 42, a master-side wireless antenna 43, and the like. These components are mounted on a control circuit board 44 of the battery control device 40 and are accommodated and fixed in an ECU case 45 serving as a housing of the battery control device 40 (indicated by a dashed-dotted line in FIG. 2).

The master-side wireless IC 42 is connected in a wired manner to the battery control MCU 41. The master-side wireless IC 42 is connected in a wired manner to the master-side wireless antenna 43.

The battery control MCU 41 is configured by a microcontroller (Micro Controller Unit) including a CPU, a ROM, a RAM, and an input/output interface. The CPU of the battery control MCU 41 loads a program stored in the ROM into the RAM and executes the program. The program stored in the ROM describes, for example, processing related to battery control.

As one example of processing related to battery control, the battery control MCU 41 is configured to acquire a voltage across terminals (total voltage) of the assembled battery 20 via a voltage sensor (not illustrated). The total voltage of the assembled battery 20 is input, for example, from a power line in the junction box 60 to which the relay switch 61 and an electric load (an electric load external to the battery pack 11) are connected. The voltage sensor may be provided within the junction box 60, within the battery control device 40, or at another suitable location.

As one example of main processing of the battery control MCU 41, the battery control MCU 41 transmits control data requesting acquisition and transmission of battery information to the battery monitoring devices 30. The battery control MCU 41 performs various processes related to monitoring of the assembled battery 20, the battery blocks 21, and the battery cells 22 based on monitoring data including battery information received from the battery monitoring devices 30. For example, the battery control MCU 41 may transmit a monitoring result (monitoring data) to the vehicle ECU 14, which is a higher-layer ECU. In that case, the battery control MCU 41 may calculate the SOC and/or SOH based on the battery information and transmit battery information including the calculated SOC and/or SOH to the vehicle ECU 14. The battery control MCU 41 controls the relay switches 61 configured to switch an electrical connection between the assembled battery 20 and the PCU 12 or the motor 13 between an energized state and a de-energized state based on the monitoring result and the like. The battery control MCU 41 may transmit an equalization signal for equalizing voltages of the respective battery cells 22. In the present embodiment, the vehicle ECU 14 issues an instruction to the PCU 12 to perform charge and discharge control of the assembled battery 20. Alternatively, the battery control MCU 41 may be configured to perform such control. As described above, the battery control MCU 41 monitors and manages the assembled battery 20, the battery block 21, and the battery cell 22.

The master-side wireless IC 42 includes an RF circuit (not illustrated), a microcomputer, a front-end circuit, and the like to wirelessly transmit and receive data, similarly to the slave-side wireless IC 32. The master-side wireless IC 42 has a transmission function and a reception function, similarly to the slave-side wireless IC 32.

The master-side wireless IC 42 demodulates monitoring data including received battery information via the master-side wireless antenna 43 and transmits the demodulated monitoring data to the battery control MCU 41. The master-side wireless IC 42 modulates data obtained by adding data necessary for wireless communication, such as communication control information, to control data received from the battery control MCU 41 and transmits the modulated data to the battery monitoring device 30 via the master-side wireless antenna 43. The data necessary for wireless communication includes, for example, an identifier (ID) and an error detection code. The master-side wireless IC 42 has functions of determining a data size, a communication format, and a schedule of communication between the battery monitoring device 30 and the battery control device 40 and detecting an error.

The master-side wireless antenna 43 has a configuration and a function similar to those of the slave-side wireless antenna 33. That is, the master-side wireless antenna 43 converts an RF signal, which is an electric signal, into a radio wave and radiates the radio wave into space, and receives a radio wave propagating through space and converts the received radio wave into an electric signal.

### Storage Case

The storage case 50 is made of a conductor such as metal. The storage case 50 has a box shape made of metal and has a substantially rectangular parallelepiped shape. The storage case 50 may be partially or entirely made of a non-conductive member such as resin. The storage case 50 accommodates the assembled battery 20, the battery monitoring devices 30, and the battery control device 40 in an internal battery accommodation space.

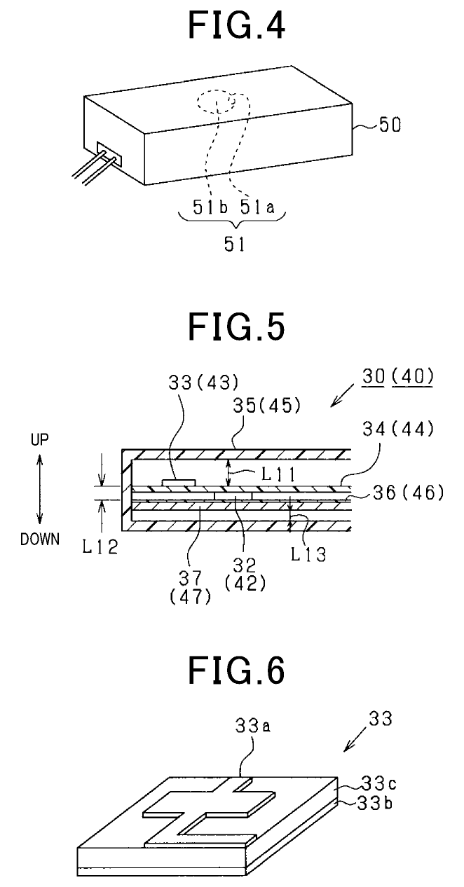

As illustrated in FIG. 4, the storage case 50 is provided with a housing explosion-proof valve 51 that releases internal gas when a pressure difference between an inside and an outside of the storage case 50 becomes equal to or greater than a predefined value. For example, the housing explosion-proof valve 51 is formed by covering a through hole 51a formed in the storage case 50 with a lid member 51b and welding the lid member 51b to the storage case 50. When a difference between an internal pressure and an external pressure reaches or exceeds a predefined value, the lid member 51b is detached, and gas escapes through the through hole 51a. The housing explosion-proof valve 51 corresponds to an opening of the storage case 50.

To facilitate operation of the housing explosion-proof valve 51, the lid member 51b may be made of resin, or the lid member 51b may have a groove so as to readily break when the air pressure increases. The lid member 51b may be thinner than the thickness of the storage case 50. The housing explosion-proof valve 51 is not limited to a configuration in which the through hole 51a is closed by the lid member 51b. For example, the storage case 50 may have a circular or hexagonal groove (thin portion) such that the storage case 50 breaks and forms the through hole 51a when the air pressure increases. The housing explosion-proof valve 51 does not need to be formed on the upper surface and may be provided on a side surface or a bottom surface. The number and arrangement of the housing explosion-proof valves 51 are arbitrary. However, the housing explosion-proof valve 51 is preferably not provided on a surface where a vehicle body blocks gas and thereby impedes escape of the gas.

The arrangement of the assembled battery 20, the battery monitoring devices 30, the battery control device 40, and the junction box 60 will now be briefly described with reference to FIG. 3. the lower surface of the storage case 50 functions as a mounting surface for mounting the storage case 50 to the vehicle 10. FIG. 3 is a plan view schematically illustrating the interior of the battery pack 11 as viewed from above in a vertical direction. As illustrated in FIG. 3, inside the substantially rectangular-parallelepiped storage case 50, a plurality of battery blocks 21 constituting the assembled battery 20 are arranged side by side in a longitudinal direction (X direction in FIG. 3). In each battery block 21, battery cells 22 constituting the battery block 21 are arranged so as to be stacked in a lateral direction (Y direction in FIG. 3) of the storage case 50. In the following, the longitudinal direction of the storage case 50 may be referred to as an X direction, the lateral direction may be referred to as a Y direction, and the vertical direction may be referred to as a Z direction.

The battery monitoring device 30 and the bus bars 23 are disposed on the upper surface (a surface on a Z-plus side in FIG. 3) of each battery block 21 and are fixed by screws or the like. The battery control device 40 and the junction box 60 are disposed at an end in the longitudinal direction (X direction). In that case, the battery control device 40 is placed directly above the junction box 60 (on the Z-plus side). The battery control device 40 is preferably disposed such that the master-side wireless antenna 43 is disposed near the upper surface of the battery block 21, more preferably at or above the upper surface. The arrangement of the assembled battery 20, the battery monitoring devices 30, the battery control device 40, and the junction box 60 illustrated in FIG. 3 is merely an example and may be arbitrarily changed. Specific modifications will be described later.

To appropriately perform wireless communication, antenna characteristics of the slave-side wireless antennas 33 and the master-side wireless antenna 43 are desirably maintained within an appropriate range under any environment. As a specific example, reuse of the battery pack 11 is being considered in view of environmental considerations. When the battery pack 11 is reused, not only the battery pack 11 as a whole but also the battery monitoring system 100 and the assembled battery 20 constituting the battery pack 11 may be reused individually. In reuse, the configuration is not necessarily reused in the same type of vehicle and may be reused in a different type of vehicle. When reused in a different type of vehicle, arrangement of the assembled battery 20 or the battery monitoring system 100 may be changed, or the storage case 50 accommodating the battery monitoring system 100 may be changed to another case.

In such a case, antenna characteristics of the slave-side wireless antennas 33 or the master-side wireless antenna 43 may be affected. The antenna characteristics include, for example, a voltage standing wave ratio (VSWR). The influence on the antenna characteristics will now be described in detail. In the SBM case 35 and the ECU case 45, at least a portion facing each of the antennas 33 and 43 is generally made of a radio-wave-transmissive material such as resin so as not to obstruct radio waves. In the present embodiment, the SBM case 35 and the ECU case 45 are made of resin. Accordingly, capacitance is generated between the antennas 33 and 43 and metal components disposed outside the cases 35 and 45 via the cases 35 and 45. The metal components include, for example, the storage case 50 and battery cases of the battery cells 22. This capacitance affects the antenna characteristics. Accordingly, shapes and sizes of the antennas 33 and 43 are designed such that the antenna characteristics become appropriate in consideration of these capacitances.

The SBM case 35 and the ECU case 45 may be collectively referred to as cases 35 and 45. The slave-side wireless antennas 33 and the master-side wireless antenna 43 may be collectively referred to as antennas 33 and 43. The monitoring circuit boards 34 and the control circuit board 44 may be collectively referred to as circuit boards 34 and 44.

However, when reused, a change in arrangement of the battery monitoring devices 30 (or the battery control device 40) or in configuration of the storage case 50 may cause capacitance generated therebetween to vary. When a ratio of a variation amount to capacitance before the change is excessively large, the antenna characteristics may be affected, and the configuration may fail to appropriately perform wireless communication. The variation amount is a difference between the capacitance before the change and the capacitance after the change. The ratio of the variation amount is a value calculated by dividing the variation amount by the capacitance before the change. In the following, the ratio of the variation amount will be referred to as a variation ratio.

Accordingly, in the first embodiment, the battery monitoring devices 30 and the battery control device 40 are configured such that the variation ratio does not become large even when the surrounding environment changes, such as during reuse. The configuration will now be described in detail with reference to FIG. 5. FIG. 5 is a side cross-sectional view schematically illustrating the interior of the SBM case 35 in the battery monitoring device 30.

As illustrated in FIG. 5, in each battery monitoring devices 30, the slave-side wireless antenna 33 is placed on the upper surface of the monitoring circuit board 34 formed in a substantially rectangular plate shape, and the SBM case 35 made of resin accommodates and fixes the monitoring circuit board 34 and the slave-side wireless antenna 33 in that state. The SBM case 35 has a flat rectangular parallelepiped shape. The slave-side wireless IC 32 is disposed on the lower surface of the monitoring circuit board 34.

The slave-side wireless antenna 33 is a pattern antenna and includes, for example as illustrated in FIG. 6, an element 33a for radiating radio waves, a ground plate 33b as a wiring pattern disposed to face the element 33a, and a dielectric 33c interposed between the element 33a and the ground plate 33b. The element 33a is a thin metal conductor and has a shape in which an L-shaped portion and a rectangular portion are combined. The rectangular portion corresponds to a stub shape. Since the rectangular portion has an open end, the shape of the rectangular portion is also referred to as an open-stub shape. Signals are input to the element 33a from a feed point (not illustrated).

The ground plate 33b is a thin, elongated plate-shaped metal conductor and is maintained at a potential corresponding to a reference potential of the monitoring circuit board 34. The element 33a is placed on the ground plate 33b via the dielectric 33c. The pattern of the element 33a is adjusted such that an impedance of the slave-side wireless antenna 33 becomes a desired impedance. The ground plate 33b is disposed on a lower side, and the element 33a is disposed on an upper side.

As illustrated in FIG. 5, a metal plate 37 as a proximate conductor is disposed beneath the monitoring circuit board 34 via an insulating sheet 36. The proximate conductor refers to a conductor present close enough to affect the antenna characteristics of the slave-side wireless antenna 33. The influence on characteristics of the antenna refers to a change in impedance of the slave-side wireless antenna 33. More specifically, the proximate conductor is a conductor that does not electrically contact the element 33a and is disposed at a distance equal to or less than a wavelength of the lowest frequency in a frequency band used for wireless communication. The metal plate 37, which is the proximate conductor in the present embodiment, will now be described in detail.

The metal plate 37 is disposed on an opposite side of the monitoring circuit board 34 from the slave-side wireless antenna 33. The metal plate 37 has a flat plate shape and is disposed with its plane parallel to the monitoring circuit board 34. Specifically, the metal plate 37 is disposed on the monitoring circuit board 34 with the insulating sheet 36 interposed therebetween. The metal plate 37 is disposed closest to the slave-side wireless antenna 33 among conductors other than conductors mounted on the monitoring circuit board 34. Specifically, in a predefined direction, the metal plate 37 is present closest to the slave-side wireless antenna 33 as compared with other conductors present inside the SBM case 35. The other conductors present inside the SBM case 35 include, for example, circuit elements (excluding circuit elements mounted on the monitoring circuit board 34), wiring, and metal components. The other conductors also include conductors present outside the SBM case 35. The conductors present outside include the storage case 50, the bus bars 23, and battery cases of the battery cells 22. Although the metal plate 37 has a flat plate shape, the flat plate shape refers to a shape whose thickness is sufficiently smaller than other dimensions and may partially include unevenness.

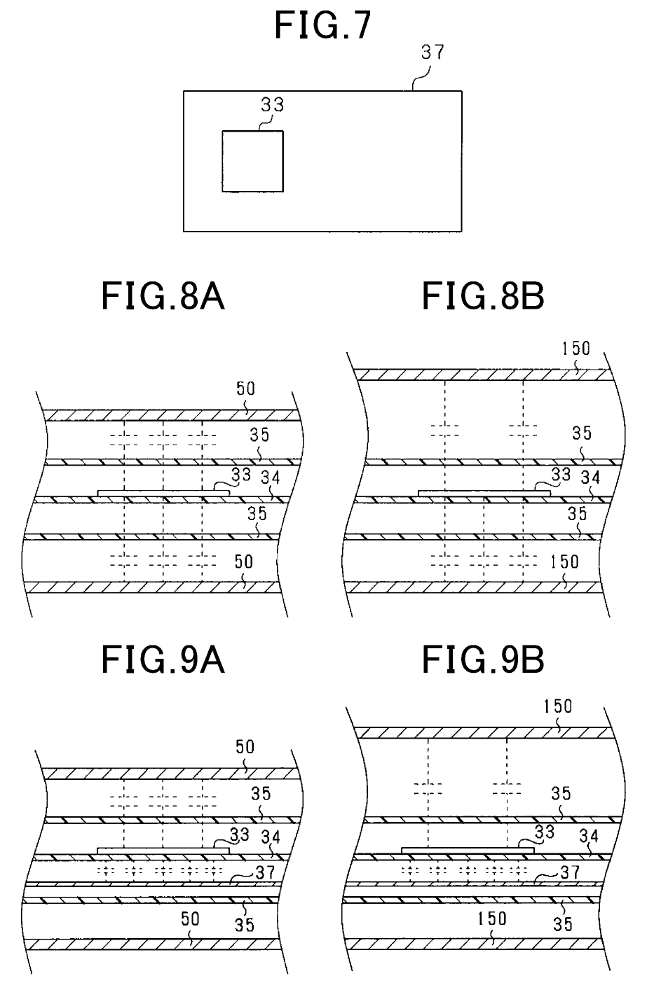

As illustrated in FIG. 7, in the predefined direction defined as a projection direction, the metal plate 37 overlaps at least a portion of a projected surface of the slave-side wireless antenna 33. The predefined direction is a direction in which an area of the projected surface of the slave-side wireless antenna 33 is maximized. In the present embodiment, the predefined direction is a direction perpendicular to the monitoring circuit board 34. The projected surface of the slave-side wireless antenna 33 includes at least all of a projected surface of the element 33a and a projected surface of the ground plate 33b. In the present embodiment, an area of the metal plate 37 is defined such that, in the vertical direction, the entire projected surface of the slave-side wireless antenna 33 overlaps the metal plate 37. That is, the area of the metal plate 37 is set such that, when the slave-side wireless antenna 33 is projected in the vertical direction, the entire projected surface of the slave-side wireless antenna 33 is covered by the metal plate 37. In the present embodiment, the metal plate 37 is disposed to cover the slave-side wireless IC 32 disposed on the lower surface of the monitoring circuit board 34.

As illustrated in FIG. 5, the monitoring circuit board 34 and the metal plate 37 are accommodated and fixed in the SBM case 35 in a stacked state. In the vertical direction of the monitoring circuit board 34, a size and a shape of the SBM case 35 and a fixed position of the monitoring circuit board 34 are defined such that a distance L11 from the upper surface of the monitoring circuit board 34 to the upper surface of the SBM case 35 is greater than a distance L12 from the slave-side wireless antenna 33 to the metal plate 37. In the vertical direction of the monitoring circuit board 34, a size and a shape of the SBM case 35 and the fixed position of the monitoring circuit board 34 are defined such that a distance L13 from the lower surface of the metal plate 37 to the lower surface of the SBM case 35 is greater than the distance L12. Accordingly, even when the external condition of the battery monitoring device 30 changes, the metal plate 37 remains the closest conductor to the slave-side wireless antenna 33 as long as the internal configuration remains unchanged.

The battery monitoring devices 30 have been described above. The battery control device 40 has a substantially similar configuration. The internal configuration of the battery control device 40 will now be briefly described with reference to FIG. 5. In the battery control device 40, the master-side wireless antenna 43 is disposed on the upper surface of the control circuit board 44, and the ECU case 45 made of resin accommodates and fixes the control circuit board 44 in that state. The master-side wireless IC 42 is disposed on the lower surface of the control circuit board 44.

The master-side wireless antenna 43 has a configuration similar to that of the slave-side wireless antenna 33. That is, the master-side wireless antenna 43 includes an element 43a for radiating radio waves, a ground plate 43b disposed to face the element 43a in an insulated state, and a dielectric 43c interposed between the element 43a and the ground plate 43b. The element 43a, the ground plate 43b, and the dielectric 43c are configured similarly to those of the slave-side wireless antenna 33, and description thereof is omitted.

A metal plate 47 serving as a proximate conductor is disposed on the lower side of the control circuit board 44 with the insulating sheet 46 interposed therebetween. The shape, size, and arrangement of the metal plate 47 are similar to those of the metal plate 37 in each battery monitoring device 30. That is, in the vertical direction, the metal plate 47 has an area that covers the entire projected surface of the master-side wireless antenna 43. The metal plate 47 covers the master-side wireless IC 42 disposed on the lower surface of the control circuit board 44. Accordingly, detailed description of the metal plate 47 is omitted.

The control circuit board 44 and the metal plate 47 are accommodated and fixed in the ECU case 45 in a stacked state. The ECU case 45 has a configuration substantially similar to that of the SBM case 35, and description thereof is omitted.

Next, operation during reuse of the battery monitoring system 100 configured as described above will be described with reference to FIGS. 8 and 9. The following description focuses on the battery monitoring devices 30, and the battery control device 40 is substantially similar.

First, a change in capacitance in a comparative example in which the metal plate 37 is absent will be described with reference to FIGS. 8A and 8B. The battery monitoring devices 30 are accommodated inside the storage case 50, which is a metal conductor. As illustrated in FIG. 8A, a capacitive coupling is formed between each slave-side wireless antenna 33 and a conductor outside the SBM case 35, through the SBM case 35 made of resin. The conductor present outside the SBM case 35 varies depending on arrangement of the battery monitoring devices 30. In FIG. 8A, for simplicity, the conductor outside the SBM case 35 corresponds to the upper surface and the lower surface of the storage case 50. In FIG. 8A, a total capacitance generated therebetween is, for example, 8 pF.

Assume that the battery monitoring devices 30 are reused and accommodated in a storage case 150 having a configuration different from that of the storage case 50. Here, as illustrated in FIG. 8B, only a distance between each slave-side wireless antenna 33 and the upper surface of the storage case 150 increases, and other conditions remain the same.

As the distance between each slave-side wireless antenna 33 and the upper surface of the storage case 150 increases, the capacitance therebetween decreases. Assume that a total capacitance after variation is, for example, 6 pF. Thus, a variation amount is 2 pF, and a variation ratio is 25 percent.

Next, a change in capacitance in the first embodiment in which the metal plate 37 is present will be described with reference to FIGS. 9A and 9B. The battery monitoring devices 30 are accommodated inside the storage case 50 that is a metal conductor. In a state before the change, as illustrated in FIG. 9A, a capacitive coupling is formed between each slave-side wireless antenna 33 and a conductor outside the SBM case 35 made of resin, through the SBM case 35. In FIG. 9A, for simplicity, the conductor outside the SBM case 35 corresponds to the upper surface of the storage case 50. As illustrated in FIG. 9A, the metal plate 37 serving as the proximate conductor is disposed beneath the monitoring circuit board 34. Accordingly, unlike FIG. 8A, substantially no capacitance is generated between the slave-side wireless antenna 33 and the lower surface of the storage case 50.

A relatively large capacitance is generated between each slave-side wireless antenna 33 and the metal plate 37. This is because a distance between the slave-side wireless antenna 33 and the metal plate 37 is smallest among the conductors outside the SBM case 35, and the overlapping area is largest. Accordingly, in FIG. 9A, the total capacitance becomes large and is, for example, 15 pF.

Assume that the battery monitoring devices 30 are reused and accommodated in the storage case 150 as in FIG. 8B. As the distance between the slave-side wireless antenna 33 and the upper surface of the storage case 150 increases, the capacitance therebetween decreases. In this case, the variation amount is 2 pF. Then, the total capacitance after variation is 13 pF, and the variation ratio is about 13 percent.

As described above, when the battery monitoring devices 30 of the first embodiment are reused, the configuration can reduce the variation ratio as compared with a case in which the metal plate 37 is absent. Therefore, the influence on characteristics of the antennas is reduced.

The above embodiment provides the following advantageous effects.

The battery monitoring devices 30 each include the metal plate 37, and the battery control device 40 includes the metal plate 47, where the metal plates 37 and 47 each serve as a proximate conductor. In the predefined direction used as a projection direction, the metal plate 37 overlaps at least a portion of a projected surface of the antenna 33, and the metal plate 47 overlaps at least a portion of a projected surface of the antenna 43. The metal plate 37 forms an electrostatic coupling with the antenna 33, and the metal plate 47 forms an electrostatic coupling with the antenna 43, thereby generating capacitance. When this capacitance is large, even if stray capacitance is generated with another conductor, the capacitance between the metal plate 37 and the antenna 33 and the capacitance between the metal plate 47 and the antenna 43 each account for a larger proportion of the total capacitance and become dominant. Even when capacitance with another conductor varies, a variation ratio can be reduced. That is, a large change in capacitance is suppressed, which can suppress the influence on characteristics of the antennas.

The metal plates 37, 47 are disposed closest to the antennas 33, 43 as compared with other conductors (excluding circuit elements mounted on the circuit boards 34, 44). This increases the capacitance between the metal plate 37 and the antenna 33 and the capacitance between the metal plate 47 and the antenna 43, thereby allowing each capacitance to remain dominant even after variation. As a result, the variation ratio is decreased.

The projected surface of each of the antennas 33, 43 is a surface that becomes maximum as compared with projected surfaces in other directions. This increases the capacitance between the metal plate 37 and the antenna 33, and the capacitance between the metal plate 47 and the antenna 43, thereby allowing each capacitance to remain dominant even after variation. As a result, the variation ratio can be decreased.

The predefined direction (projection direction) is a vertical direction of the monitoring circuit board 34 (or, in the battery control device 40, the control circuit board 44). When the metal plate 37 is fixed to the circuit board 34, a distance and an overlapping area between the antenna 33 and the metal plate 37 are stabilized, and variation in capacitance is reduced. Similarly, when the metal plate 47 is fixed to the circuit board 44, a distance and an overlapping area between the antenna 43 and the metal plate 47 are stabilized, and variation in capacitance is reduced.

The metal plates 37, 47 have a flat plate shape, and their planes are disposed parallel to the circuit boards 34, 44. This increases capacitance between the metal plate 37 and the antenna 33 and capacitance between the metal plate 47 and the antenna 43. Therefore, even when a configuration of the battery pack 11 on the side where the metal plates 37, 47 are disposed is changed, the distance and overlap area between the antenna 33 and the metal plate 37 and the distance and overlap area between the antenna 43 and the metal plate 47 are stabilized, which makes the capacitance less likely to vary.

The metal plates 37 and 47 are disposed on lower surfaces of the circuit boards 34 and 44 opposite respective upper surfaces on which the elements 33a and 43a are disposed. This arrangement prevents the metal plates 37 and 47 from interfering with radio waves radiated from the elements 33a and 43a.

The slave-side wireless IC 32 and the master-side wireless IC 42 are disposed on lower surfaces of the circuit boards 34 and 44 opposite the upper surfaces. The metal plates 37 and 47 cover the respective ICs. The metal plates 37, 47 can block external noise and can suppress the influence on the slave-side wireless IC 32 and the master-side wireless IC 42. Since the slave-side wireless IC 32 and the master-side wireless IC 42 are disposed on surfaces different from the surfaces on which the elements 33a and 43a are disposed, the ICs and the elements do not adversely affect each other.

In the predefined vertical direction, the metal plates 37 and 47 fully overlap the projected surfaces of the antennas 33 and 43. This maximizes the overlap areas, increases the proportion of capacitance between the metal plate 37 and the antenna 33 and the proportion of capacitance between the metal plate 47 and the antenna 43 s much as possible, and reduces the variation ratio.

The elements 33a, 43a have an L shape and a stub shape. This enables adjustment of capacitance between the elements 33a, 43a and the ground plates 33b, 43b, impedance of the antennas 33, 43, capacitance between the antennas 33, 43 and the metal plates 37, 47, and the like, thereby improving antenna characteristics.

The insulating sheet 36 is interposed between the antenna 33 (more specifically, the circuit board 34) and the metal plate 37, and the insulating sheet 46 is interposed between the antenna 43 (more specifically, the circuit board 44) and the metal plate 47. With this configuration, even when a high-voltage source such as the battery cells 22 is disposed below the battery monitoring devices 30 or the battery control device 40 due to a change in arrangement, the insulating sheets 36, 46 can prevent leakage.

### Modifications of First Embodiment

Modifications in which part of the configuration of the battery pack 11 is changed will now be described.

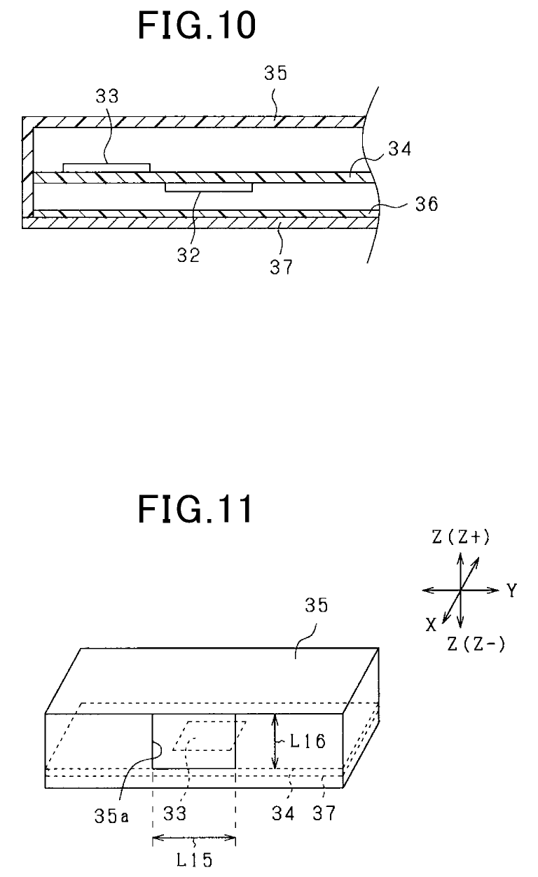

(1A) In the first embodiment described above, each of the SBM case 35 and the ECU case 45 is made of resin, but a portion thereof may be made of a conductor (e.g., metal). In that case, for example as illustrated in FIG. 10, the lower surface of the SBM case 35 may be made of metal, and the lower surface may function as the metal plate 37. This can reduce the number of components. The ECU case 45 may be configured similarly.

(1B) In the first embodiment described above, when each of the SBM case 35 and the ECU case 45 is formed, in whole or in part, of a conductive material, each case includes a transmission portion configured to allow radio waves from a corresponding antenna 33, 43 to pass through the case.

For example, when the SBM case 35 is made of metal, as illustrated in FIG. 11, a passage opening 35a may be provided on a side surface of the SBM case 35 at a position facing the slave-side wireless antenna 33 (near a center in the Y direction in FIG. 11). The passage opening 35a is provided, in a propagation path of radio waves, on a side of a communication partner (the battery control device 40) relative to the slave-side wireless antenna 33. The passage opening 35a is provided, in the propagation path of the radio waves, on a side opposite to the metal plate 37 with reference to the slave-side wireless antenna 33. Specifically, the passage opening 35a is provided on the side surface of the SBM case 35 above (on a Z+ side of) the monitoring circuit board 34 and extends to the upper surface of the SBM case 35. The passage opening 35a may be provided from the side surface to the upper surface of the SBM case 35, and it is further preferable that a portion of the upper surface of the SBM case 35 facing the slave-side wireless antenna 33 also serves as the passage opening 35a.

In FIG. 11, the passage opening 35a is covered with a resin cover. Alternatively, the passage opening 35a may have any configuration as long as radio waves are allowed to pass therethrough, and the passage opening 35a may be left open without any member provided therein. Accordingly, even when the metal plate 37 is provided, radio waves can be appropriately transmitted and received.

The passage opening 35a may preferably be provided at a position facing the slave-side wireless antenna 33 and may preferably be provided on a side opposite to the metal plate 37. That is, when the metal plate 37 is provided on the lower surface side (Z− side) of the monitoring circuit board 34, the passage opening 35a is preferably provided above (on a Z+ side of) the upper surface on which the slave-side wireless antenna 33 is provided. Accordingly, even when the metal plate 37 is provided, radio waves can be appropriately transmitted and received.

A width dimension of the passage opening 35a is set to be one-half or more of a wavelength of radio waves radiated from the slave-side wireless antenna 33. The width dimension may be a dimension in any direction and may be either a vertical width or a horizontal width. For example, in a direction orthogonal to the Z direction (a vertical direction of the monitoring circuit board 34 serving as the projection direction), in the modified example illustrated in FIG. 11, a width dimension L15 of the passage opening 35a in the Y direction is set to be one-half or more of the wavelength of the radio waves radiated from the slave-side wireless antenna 33. Accordingly, a propagation path of the radio waves passing through the passage opening 35a in the Y direction can be appropriately secured.

(1C) In the first embodiment described above, in the projection direction (the Z direction, which is a vertical direction of the monitoring circuit board 34), it is preferable that no conductor be disposed on a side opposite to the metal plate 37 with respect to the slave-side wireless antenna 33 (that is, on an upper side of the monitoring circuit board 34). However, when any conductor is disposed on that side, a distance between the conductor and the slave-side wireless antenna 33 is preferably one-half or more of a wavelength of radio waves radiated from the slave-side wireless antenna 33. The ECU case 45 may be configured in the same manner.

For example, when the upper surface of the storage case 50, which is formed of a conductive material, is disposed in the Z direction as in the first embodiment, a distance between the upper surface of the storage case 50 and the slave-side wireless antenna 33 is set to be one-half or more of a wavelength of radio waves radiated from the slave-side wireless antenna 33. This allows a propagation path of the radio waves in the Z direction to be appropriately secured.

As illustrated in a modification depicted in FIG. 11, when the upper surface of the SBM case 35, which is formed of a conductive material, is disposed in the Z direction, a distance L16 between the upper surface of the SBM case 35 and the slave-side wireless antenna 33 is one-half or more of a wavelength of radio waves radiated from the slave-side wireless antenna 33. This allows a propagation path of radio waves passing through the passage opening 35a in the Z direction to be appropriately secured.

(1D) In the first embodiment described above, a distance between the upper surface of the SBM case 35 and the slave-side wireless antenna 33 is preferably one-half or more of a wavelength of radio waves radiated from the slave-side wireless antenna 33. Accordingly, even when an external configuration of the SBM case 35 is changed, for example, when a conductor is disposed outside the SBM case 35, the SBM case 35 can maintain a size of a propagation path in the Z direction (vertical direction) at one-half or more of the wavelength of the radio waves. Therefore, a propagation path of the radio waves in the Z direction can be appropriately secured. The ECU case 45 may be configured in the same manner.

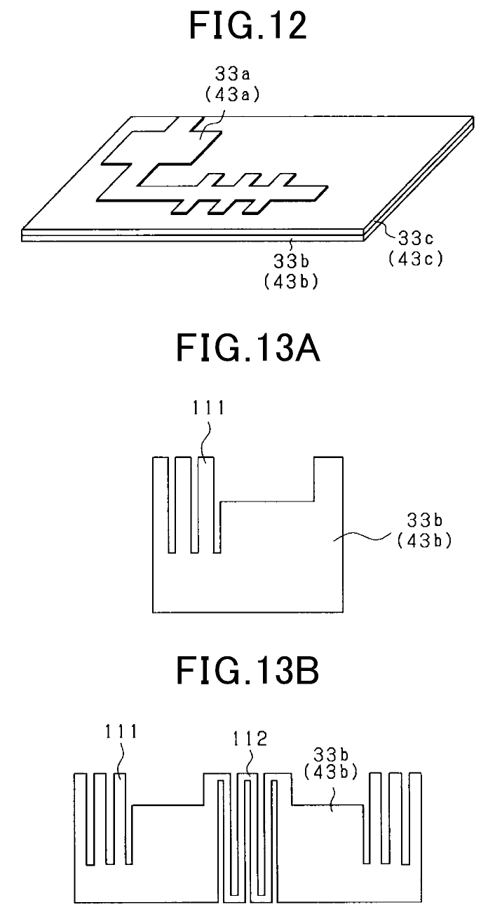

(1E) In the first embodiment described above, the shapes of the elements 33a, 43a may be arbitrarily changed to acquire desired antenna characteristics. For example, vertical and horizontal dimensions of the stub shape may be changed, or the stub shape may be omitted. The shape is not limited to an L shape. As illustrated in FIG. 12, the elements 33a and 43a may have a comb-tooth shape 133. This enables adjustment of impedance and capacitance to arbitrary values.

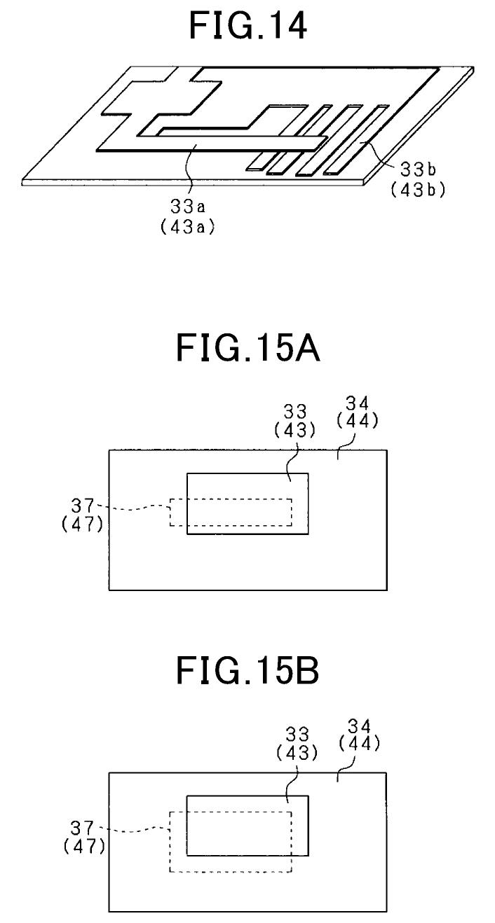

(1F) In the first embodiment described above, shapes of the ground plates 33b, 43b may be arbitrarily changed. For example, the ground plates 33b and 43b may be formed in a comb-tooth shape 111. The ground plates 33b and 43b may be formed in a meandering shape 112. The ground plates 33b, 43b do not need to face all regions of the elements 33a, 43a. As illustrated in FIG. 14, the ground plates 33b and 43b may not overlap a portion of the elements 33a and 43a. This enables appropriate adjustment of impedance and the like. In FIG. 14, the dielectrics 33c, 43c are omitted.

Regardless of shapes of the elements 33a, 43a and the ground plates 33b, 43b, the projected surface of each antenna 33 includes at least all of a projected surface of the element 33a and a projected surface of the ground plate 33b, and the projected surface of the antenna 43 includes at least all of a projected surface of the element 43a and a projected surface of the ground plate 43b.

(1G) In the first embodiment described above, the metal plates 37 and 47 are configured to cover the lower surfaces of the circuit boards 34 and 44. However, as long as at least a portion of a projected surface of each antenna 33, 43 overlaps with a corresponding metal plate 37, 47, the size of each metal plate may be modified as desired. For example, as illustrated in FIG. 15A, about half of the projected surface of each antenna 33, 43 may overlap with a corresponding metal plate 37, 47. As illustrated in FIG. 15B, the projected surface of each antenna 33, 43 may have the same area as a corresponding metal plate 37, 47, while only a portion of the projected surface overlaps with the metal plate. Although not illustrated, metal plates 37 and 47 that completely coincide with the projected surfaces of the antennas 33 and 43 may be provided. It is preferable to set the sizes of the metal plates 37 and 47 such that one half or more of the projected surface of each antenna 33, 43 may overlap with a corresponding metal plate 37, 47.

### Second Embodiment

The battery pack according to a second embodiment will be described below.

In the battery monitoring system 100 that utilizes wireless communication as in the first embodiment, communication is affected by electromagnetic noise. Accordingly, a storage case 50 (a housing of the battery pack 11) that accommodates the battery monitoring system 100 utilizes an electromagnetic shielding member (a metal conductor in the first embodiment) that absorbs or reflects electromagnetic noise from outside. As a document describing use of an electromagnetic absorbing member in a storage case, for example, JP-T-2020-510956 is available.

However, a source of electromagnetic noise (noise source) does not necessarily exist outside the storage case 50 and may exist inside the storage case 50. In the first embodiment, for example, a main noise source present inside the storage case 50 of the battery pack 11 is a junction box 60. The junction box 60 includes relay switches 61 configured to switch a current path. Accordingly, when wireless communication is utilized inside the storage case 50, it is necessary to suppress the influence of electromagnetic noise from the noise source inside the storage case 50.

The second embodiment is provided in view of the circumstances described above. One object of the second embodiment is to suppress the influence of noise generated inside the storage case 50. A detailed description will be given below.

As described in the first embodiment, the battery control device 40 is disposed in the vicinity of the junction box 60 (directly above in the first embodiment) in order to acquire a total voltage (terminal-to-terminal voltage) of the assembled battery 20 from the junction box 60. A relay switch 61 of the junction box 60 is connected to an external electrical load (such as an inverter) and is susceptible to noise introduced through wiring. The relay switch 61 can also generate electromagnetic noise during switching operation. Accordingly, the junction box 60 may be regarded as a noise source inside the storage case 50 (battery accommodation space).

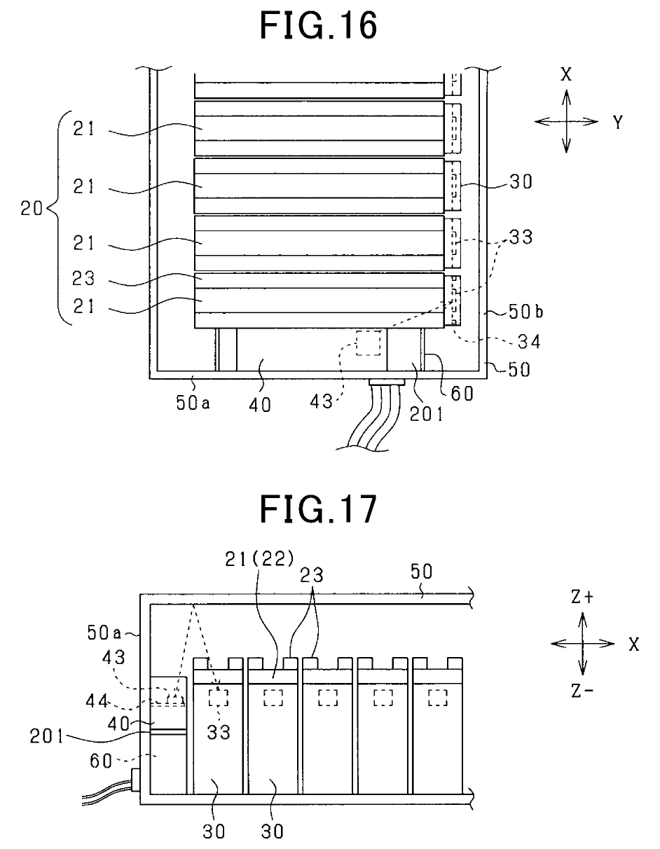

In the second embodiment, as illustrated in FIGS. 16 to 17, an electromagnetic shield 201 serving as an electromagnetic shielding member is provided between the battery control device 40 and the junction box 60 serving as a noise source, thereby blocking electromagnetic noise from reaching the battery control device 40. The battery cells 22 serving as an electromagnetic shielding member are provided between the battery monitoring device 30 and the junction box 60 serving as a noise source, thereby blocking electromagnetic noise from reaching the battery monitoring device 30.

Details will be described. First, the arrangement of the battery monitoring devices 30, the battery control device 40, and the junction box 60 in the second embodiment will be described. FIG. 16 is a top view of the interior of the storage case 50 in the second embodiment (as viewed from the Z+ direction), and FIG. 17 is a side view of the interior of the storage case 50 in the second embodiment (as viewed from the Y direction).

As illustrated in FIG. 16, a plurality of battery blocks 21 are arranged side by side in the longitudinal direction (X direction) of the storage case 50. The battery control device 40 and the junction box 60 are disposed between one of side walls 50a of the storage case 50 in the X direction and a side surface of the assembled battery 20 (more specifically, the battery block 21 disposed at one end in the X direction). The battery control device 40 is disposed directly above the junction box 60. As illustrated in FIG. 17, the battery control device 40 and the junction box 60 are disposed below an upper surface of the battery block 21.

In the present embodiment, since the junction box 60 is provided directly below the battery control device 40, an electromagnetic shield 201 is provided under the battery control device 40. The electromagnetic shield 201 is formed of a conductive member. In the present embodiment, the electromagnetic shield 201 is formed of a thin metal plate.

The electromagnetic shield 201 has a size sufficient to at least cover components of the battery control device 40 that are susceptible to electromagnetic noise, such as the battery control MCU 41, the master-side wireless IC 42, and the master-side wireless antenna 43. Preferably, the electromagnetic shield 201 is sized to entirely cover a lower surface of the control circuit board 44, more specifically, a lower surface of the ECU case 45. In the second embodiment, the electromagnetic shield 201 is configured to substantially cover an upper surface of the junction box 60.

In the battery control device 40, the master-side wireless antenna 43 is mounted on an upper surface of the control circuit board 44 and radiates radio waves upward. In FIGS. 16 and 17, an example of radio waves radiated from the master-side wireless antenna 43 is illustrated by broken lines. Accordingly, the electromagnetic shield 201 prevents the radio waves from being blocked. In a frequency band used for wireless communication, an intensity of radio waves radiated from the battery control device 40 and input to the battery monitoring device 30 serving as a communication partner is set to be higher than an intensity of electromagnetic noise generated from the junction box 60.

Meanwhile, as illustrated in FIG. 16, a plurality of battery monitoring devices 30 are disposed between one of side walls 50b of the storage case 50 in the lateral direction (Y direction) and a side surface of the assembled battery 20 (more specifically, one side surface of each battery block 21 in the Y direction). As illustrated in FIG. 17, for each of the plurality of battery monitoring devices 30, the battery monitoring device 30 is disposed below an upper surface of the battery block 21. For spatial reasons, the battery monitoring device 30 is arranged vertically (a vertical direction of the monitoring circuit board 34 is the Y direction), but the orientation may be arbitrarily changed. The slave-side wireless antenna 33 is installed, in the Y direction, on a surface opposite to the battery block 21 (on a side of the side wall 50b of the storage case 50). As illustrated in FIG. 17, the slave-side wireless antenna 33 is installed above the junction box 60 in the Z direction.

In this manner, the battery block 21 is disposed between the junction box 60 and the battery monitoring device 30, and a battery case of the battery block 21 (or a battery case of the battery cell 22) is formed of a metal conductor that blocks electromagnetic noise. This allows the battery case to function as an electromagnetic shielding member interposed between the junction box 60 and the battery monitoring device 30. In a frequency band used for wireless communication, an intensity of radio waves radiated from each battery monitoring device 30 and input to the battery control device 40 serving as a communication partner is set to be higher than an intensity of electromagnetic noise generated from the junction box 60.

For each of the plurality of battery monitoring devices 30, the slave-side wireless antenna 33 is disposed on an upper side portion of the monitoring circuit board 34 in the Z direction and radiates radio waves (indicated by broken lines) upward. Accordingly, radio waves radiated upward from the battery monitoring device 30 are reflected by the upper surface (ceiling) of the storage case 50 and are input to the battery control device 40. The radio-wave path indicated by broken lines in FIGS. 16 and 17 is an example. Radio waves radiated from the battery monitoring device 30 may be once reflected by the side wall 50b of the storage case 50 and then repeatedly reflected by the upper surface of the storage case 50 or the battery case before being input to the battery control device 40. Similarly, radio waves radiated upward from the battery control device 40 are reflected by the upper surface of the storage case 50 and are input to the battery monitoring devices 30. This radio-wave path is also an example. Radio waves radiated from the battery control device 40 may be repeatedly reflected by the upper surface of the storage case 50 or the battery case, then reflected by the side wall 50b of the storage case 50, and finally input to the battery monitoring devices 30.

Electromagnetic noise radiated from the sides of the junction box 60 may be reflected by the side walls 50a and 50b of the storage case 50 and propagate past the battery block 21 to reach each battery monitoring device 30 or the battery control device 40. To suppress the influence of such electromagnetic noise, side surfaces of the junction box 60, side surfaces of each battery monitoring device 30, or side surfaces of the battery control device 40 may be covered with an electromagnetic shield.

According to the above embodiment, the following effects are achieved.

The electromagnetic shield 201 is interposed between the battery control device 40 and the junction box 60. This can suppress the influence of electromagnetic noise from the junction box 60 on the battery control device 40. Similarly, for each battery monitoring device 30, the battery cells 22 (specifically, the battery case thereof), which function as an electromagnetic shielding member, are interposed between the battery monitoring device 30 and the junction box 60. This can suppress the influence of electromagnetic noise from the junction box 60 on the battery monitoring device 30.

In the battery accommodation space of the storage case 50, the slave-side wireless antenna 33 of each battery monitoring device 30 and the master-side wireless antenna 43 of the battery control device 40 are disposed above the junction box 60, and communication is performed by reflecting radio waves off the upper surface of the storage case 50. This can prevent radio waves from being blocked by the junction box 60, and appropriate wireless communication can be achieved.

The slave-side wireless antenna 33 of each battery monitoring device 30 and the master-side wireless antenna 43 are disposed above the electromagnetic shield 201, and the junction box 60 is separated by the electromagnetic shield 201. Therefore, even without providing an electromagnetic shield on a side surface, noise generated by the junction box 60 can be made less likely to reach the antennas 33 and 43.

The radio-wave intensity of radio waves radiated from the battery monitoring device 30 and the battery control device 40 is higher than the radio-wave intensity of electromagnetic noise generated from the junction box 60. Therefore, the influence of electromagnetic noise can be suppressed.

### Modifications of Second Embodiment

Modifications of the second embodiment, in which part of the configuration of the battery pack 11 is changed, are described below.

(2A) In the second embodiment described above, the SBM case 35 and the ECU case 45 are formed of resin. Alternatively, at least a portion thereof may be formed of an electromagnetic shielding material such as a metal. In this case, it is preferable that, in the SBM case 35 or the ECU case 45, a surface thereof disposed closer to the junction box 60 be configured as the electromagnetic shielding member. For example, as illustrated in FIG. 17, when the junction box 60 is disposed directly below the battery control device 40, a lower surface of the ECU case 45 may be formed of a metal conductor, and the lower surface may function as an electromagnetic shield (electromagnetic shielding member). In this case, the electromagnetic shield 201 can be omitted, thereby reducing the number of components. Similarly, in the SBM case 35, a left side surface thereof (a side surface thereof closer to the junction box 60) may be formed of an electromagnetic shielding member.

(2B) In the second embodiment described above, when each of the SBM case 35 and the ECU case 45 is formed, in whole or in part, of a conductor (such as metal), it is necessary to provide a passage portion that allows radio waves from the antennas 33 and 43 to pass therethrough.

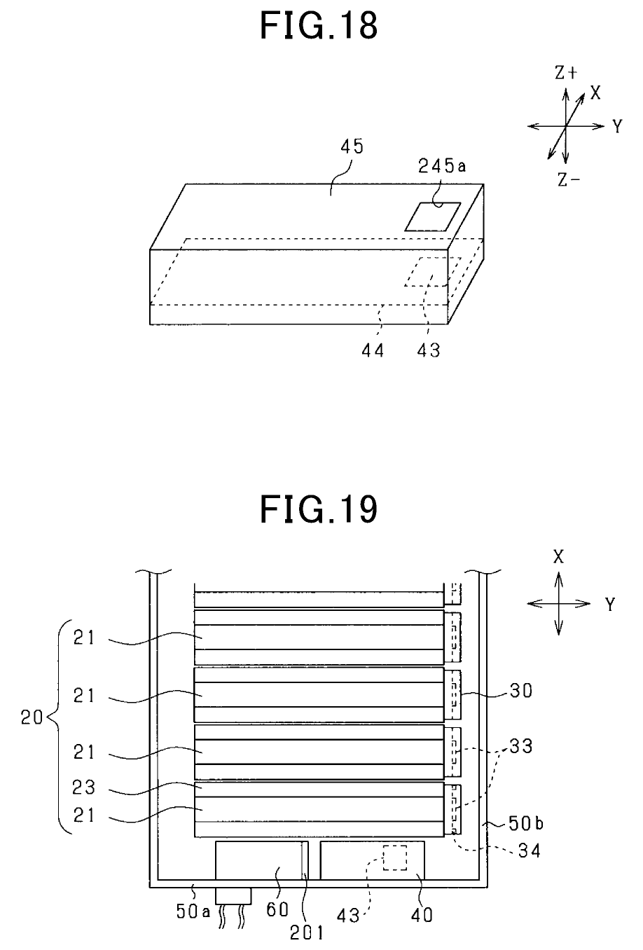

For example, as illustrated in FIGS. 16 and 17, in a case of the battery control device 40 in which a propagation path of radio waves extends upward (in the Z+ direction) and the electromagnetic shield 201 is disposed directly below the battery control device 40, as illustrated in FIG. 18, a passage opening 245a may be provided at a position on an upper surface of the ECU case 45 facing the master-side wireless antenna 43 (near a right side in FIG. 18).

In FIG. 18, the passage opening 245a is covered with a resin cover. Alternatively, the passage opening 245a may be configured in any manner as long as it allows radio waves to pass therethrough, and may be left as an opening without any member provided thereon. The passage opening 245a is disposed, in a propagation path of the radio waves, on a side of a communication partner relative to the antennas 33 and 43, while being arranged so as not to be disposed on a side of the junction box 60. That is, in the example of FIG. 18, the passage opening 245a is formed in an upper surface of the ECU case 45 (a surface opposite from the junction box 60).

In this case, a lower surface of the ECU case 45 may be formed of a conductor such as metal so as to function as an electromagnetic shielding member (electromagnetic shield). Accordingly, it is not necessary to provide an electromagnetic shielding member (such as the electromagnetic shield 201) outside the battery control device 40, thereby reducing the number of components.

Further, as illustrated in FIGS. 16 and 17, in a case of each battery monitoring device 30 in which a propagation path of radio waves extends upward (Z+ direction) and the battery cells 22 (battery block 21) are disposed on a side surface in the Y direction, similarly, a passage opening may be provided at a position on an upper surface (Z+ surface) of the SBM case 35 facing the slave-side wireless antenna 33 (near a center in the X direction). When a propagation path is assumed in which radio waves are reflected by the side wall 50b of the storage case 50 and are input and output from a side of the battery monitoring device 30 facing the side wall 50b, a passage opening may be provided at a position on a side surface of the SBM case 35 (a side surface facing the side wall 50b) corresponding to the slave-side wireless antenna 33. It is preferable that the passage opening provided in the SBM case 35 open in a direction different from a side of the battery cells 22 that function as the electromagnetic shielding member.

(2C) As the antennas 33 and 43 in the second embodiment, directional antennas having directivity in radiated radio waves may be adopted. A directional antenna is an antenna that has higher radio wave intensity in a predetermined direction. When directional antennas are adopted, it is preferable that the orientation of each antenna be determined such that a direction in which radio waves radiated from the directional antenna are strong faces a communication partner while not facing a noise source or an electromagnetic shielding member.

For example, as illustrated in FIGS. 16 and 17, in a case of the battery control device 40 in which the junction box 60 and the electromagnetic shield 201 are disposed directly below the battery control device 40 and a propagation path of radio waves is provided above the battery control device 40, it is preferable that the orientation of the directional antenna be determined such that a direction in which radio waves radiated from the directional antenna are strong faces upward (toward the battery monitoring device 30 along the propagation path) while not facing downward (toward the junction box 60 or the like).

Similarly, as illustrated in FIGS. 16 and 17, in a case of the battery monitoring device 30 in which the battery cells 22 (battery block 21) are disposed on one side in the Y direction, the side wall 50b of the storage case 50 is disposed on the other side, and a propagation path of radio waves is provided on an upper side, the orientation of the directional antenna is determined such that a direction in which radio waves radiated from the directional antenna are strong faces upward (toward the battery control device 40 along the propagation path) while not facing laterally (toward the battery cells 22 or the side wall 50b). When a propagation path is assumed in which radio waves are reflected by the side wall 50b of the storage case 50 and are input and output from a side of the battery monitoring device 30 facing the side wall 50b, the orientation of the directional antenna may be determined such that a direction in which radio waves radiated from the directional antenna are strong faces a side surface of the SBM case 35 (the side surface facing the side wall 50b).

This can prevent radio waves from the directional antenna from being blocked due to an influence of the electromagnetic shielding member or the noise source, achieving appropriate wireless communication.

(2D) In the second embodiment and its modifications described above, an arrangement of the battery block 21 (including the battery cells 22), the battery monitoring device 30, the battery control device 40, and the junction box 60 may be arbitrarily changed. Hereinafter, modifications relating to the arrangement will be described with reference to FIGS. 19 to 23.

In a modification illustrated in FIG. 19, the battery control device 40 and the junction box 60 are disposed between one of side walls 50a in the X direction of the storage case 50 and a side surface of the assembled battery 20. The battery control device 40 is disposed side by side with the junction box 60 in the Y direction. In FIG. 19, the junction box 60 is disposed on a left side and the battery control device 40 is disposed on a right side in the Y direction. In the modification of FIG. 19, the electromagnetic shield 201 is disposed between the junction box 60 and the battery control device 40. Specifically, the electromagnetic shield 201 substantially covers the side surface of the junction box 60 located closer to the battery control device 40 in the Y direction (i.e., the right-side surface of the junction box 60 in FIG. 19).

In the modification illustrated in FIG. 19, when the passage opening 245a that allows radio waves to pass is provided in the ECU case 45 similarly to the above modification, the opening may be provided so as to open toward a communication partner while not opening toward the junction box 60, which is a noise source, or the electromagnetic shield 201. For example, the passage opening 245a may be provided at a position corresponding to the master-side wireless antenna 43 on an upper surface of the ECU case 45 or on a side surface facing the battery monitoring device 30 in the Y direction (the right-side surface in FIG. 19). When a directional antenna is adopted for the battery control device 40, the orientation of the directional antenna may be determined such that a direction of higher radio wave intensity faces a communication partner while not facing the junction box 60 or the electromagnetic shield 201. For example, in the example of FIG. 19, the direction of higher radio wave intensity may be set to face upward or rightward in FIG. 19.

Similarly, for each battery monitoring device 30, when a passage opening that allows radio waves to pass is provided in the SBM case 35, the opening may be provided at a position corresponding to the slave-side wireless antenna 33 on an upper surface of the SBM case 35, on a side surface of the SBM case 35 facing the battery control device 40 in the X direction, or on a side surface of the SBM case 35 facing the side wall 50b of the storage case 50 in the Y direction. When a directional antenna is adopted for the battery monitoring device 30, in the example of FIG. 19, the direction of higher radio wave intensity may be set to face upward or toward the battery monitoring device 30 along the propagation path.

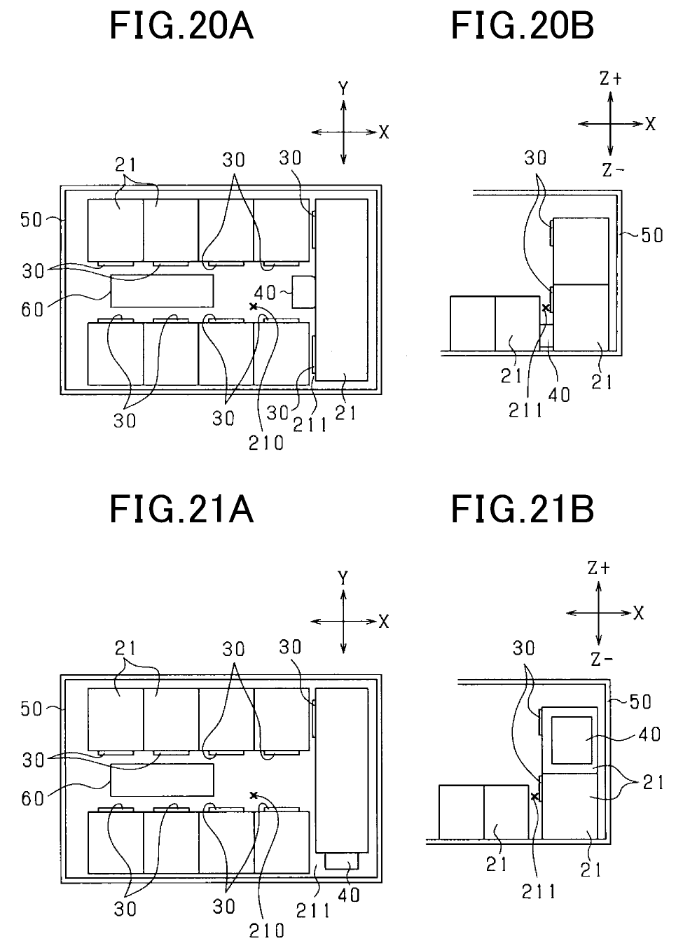

In a modification illustrated in FIG. 20A, the battery blocks 21 (or battery cells 22) are arranged in two rows in the X direction so as to leave a gap at a center in the lateral direction (Y direction) of the storage case 50. Hereinafter, the central gap in the Y direction is referred to as a central passage 210. Further, at one end in the X direction of the storage case 50, as illustrated in FIG. 20B, the battery blocks 21 (or battery cells 22) are placed in multiple stages (two stages in FIG. 20) stacked in the Z direction. A slight gap 211 is formed in the X direction between the battery blocks 21 stacked in multiple stages and the single-stage battery blocks 21.

The battery control device 40 is disposed in the central passage 210. The location where the battery control device 40 is disposed in the central passage 210 is arbitrary. For example, in FIG. 20A, it is disposed near the battery blocks 21 stacked in multiple stages.

The battery monitoring devices 30 are respectively fixed to side surfaces of the battery blocks 21 facing the central passage 210. As illustrated in FIG. 20B, the battery monitoring devices 30 are respectively fixed to side surfaces of the battery blocks 21 stacked in multiple stages (side surfaces facing the battery control device 40 in the X direction). In this modification, the battery monitoring devices 30 are fixed in a vertical orientation (with a vertical direction of the monitoring circuit board 34 being the Y direction or the X direction), but the orientation may be arbitrarily changed.

The battery monitoring devices 30 and the battery control device 40 disposed in the central passage 210 perform wireless communication using the central passage 210 as a propagation path. The battery monitoring devices 30 fixed to the side surfaces of the battery blocks 21 stacked in multiple stages perform wireless communication using the gap 211 formed between the stacked battery blocks 21 and the single-stage battery blocks 21, or an upper space of the battery blocks 21, as a propagation path.

The junction box 60 is disposed at an arbitrary position in the central passage 210. Since the junction box 60 is covered with a metal case (electromagnetic shielding member), leakage of electromagnetic noise to an outside of the junction box 60 can be suppressed. Accordingly, even when the central passage 210 is used as a propagation path of radio waves, the influence of electromagnetic noise generated from the junction box 60 can be suppressed.

In a modification illustrated in FIGS. 21A and 21B, the arrangement of the battery blocks 21, the battery monitoring devices 30, and the junction box 60 is similar to that in the modification of FIGS. 20A and 20B. As illustrated in FIG. 21A, the battery control device 40 is fixed to a side surface of the battery blocks 21 stacked in multiple stages in the Y direction. The battery control device 40 uses an upper space of the battery blocks 21 as a propagation path of radio waves.

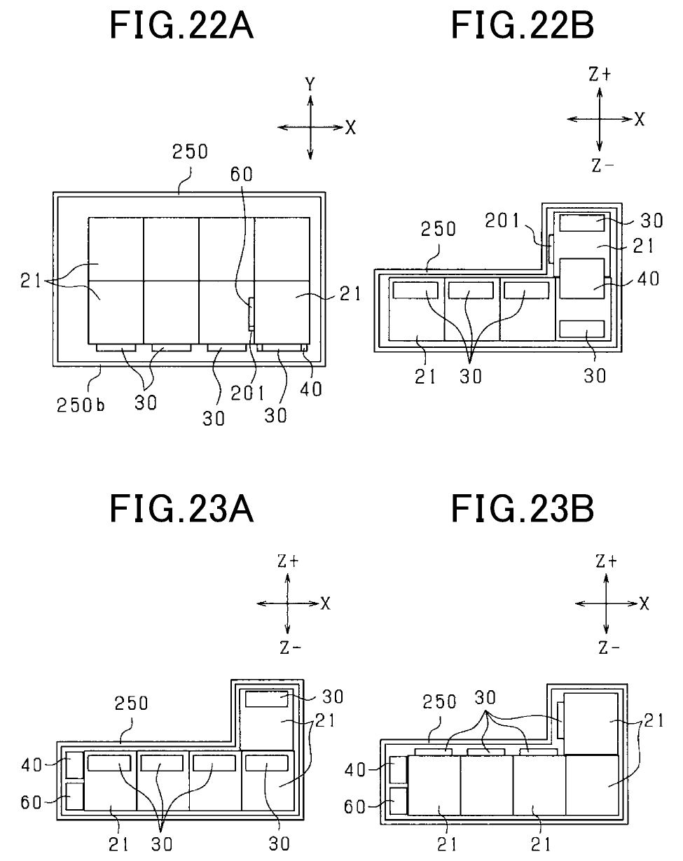

In a modification illustrated in FIGS. 22A and 22B, as illustrated in FIG. 22B, a storage case 250 having an L-shaped (step-shaped) side view (as viewed from the Y direction) is used. The battery blocks 21 (or battery cells 22) are aligned in the X direction so as to form one or more rows in the lateral direction (Y direction) of the storage case 250. Further, at one end in the longitudinal direction (X direction) of the storage case 250, the battery blocks 21 (or battery cells 22) are stacked in multiple stages (two stages in FIGS. 22A and 22B) in the vertical direction (Z direction).

As illustrated in FIG. 22B, the battery monitoring devices 30 are fixed to side surfaces of the battery blocks 21 (at one end in the Y direction). The battery control device 40 is fixed to the side surfaces of the battery blocks 21 stacked in two stages (the same side surfaces to which the battery monitoring devices 30 are fixed). The battery control device 40 is disposed toward the bottom of the upper battery block 21 so as not to interfere with the battery monitoring devices 30.

The battery monitoring devices 30 and the battery control device 40 perform wireless communication using a space between the side wall 250b in the Y direction and the battery blocks 21 in the storage case 250, that is, a lateral space in the Y direction within an interior (battery accommodation space) of the storage case 250.

As illustrated in FIG. 22A, the junction box 60 is fixed to a side surface of the upper battery block 21 among the battery blocks 21 stacked in two stages in the X direction. In this modification, the electromagnetic shield 201 is provided so as to cover a side surface of the junction box 60 on a side of the battery monitoring devices 30 and the battery control device 40 in the Y direction. This can suppress electromagnetic noise from being radiated from the side surface of the junction box 60 toward the battery monitoring devices 30 and the battery control device 40.

A side surface of the junction box 60 in the X direction is covered by the battery block 21 or a side wall of the storage case 250. Accordingly, radiation of electromagnetic noise from the side surface of the junction box 60 in the X direction can be suppressed.

A further modification to the modification illustrated in FIGS. 22A and 22B is illustrated in FIGS. 23A and 23B. As illustrated in FIG. 23A, the junction box 60 and the battery control device 40 may be disposed at one end side in the X direction of the storage case 250 (opposite to the two-stage battery blocks 21). In this case, the battery control device 40 may be disposed directly above the junction box 60, and the electromagnetic shield 201 may be disposed so as to cover an upper surface of the junction box 60. The battery control device 40 and the battery monitoring devices 30 perform wireless communication using a space between the side wall 250b in the Y direction and the battery blocks 21 as a propagation path of radio waves.

In the example of FIG. 23B, similarly to FIG. 23A, the junction box 60 and the battery control device 40 are disposed at one end side in the X direction of the storage case 250 (opposite to the two-stage battery blocks 21). In FIG. 23B as well, the battery control device 40 is disposed directly above the junction box 60, and the electromagnetic shield 201 is disposed so as to cover an upper surface of the junction box 60. In the example of FIG. 23B, the battery monitoring devices 30 are disposed on upper surfaces of the battery blocks 21. Further, a battery monitoring device 30 is disposed on a side surface of the upper battery block 21 in the X direction. In the example of FIG. 23B, the battery control device 40 and the battery monitoring devices 30 perform wireless communication using an upper space of the battery blocks 21 as a propagation path of radio waves.

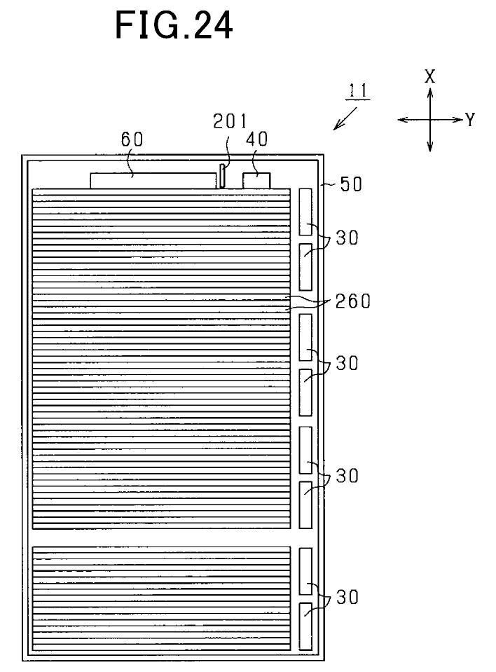

(2E) In the second embodiment and its modifications described above, as illustrated in FIG. 24, long plate-shaped blade cells 260 extending in the Y direction of the storage case 50 may be adopted as the battery cells. The blade cells 260 are stacked in the X direction of the storage case 50. Electrode terminals of each blade cell 260 are arranged on one side or both sides in the Y direction. The electrode terminals of the blade cell 260 may be provided on an upper surface of the blade cell 260.

In the Y direction, a plurality of battery monitoring devices 30 are disposed on one end side (right end side in FIG. 24) of the blade cells 260. At one end side in the X direction of the storage case 50, the junction box 60 and the battery control device 40 are disposed side by side in the Y direction. As illustrated in FIG. 24, the electromagnetic shield 201 is disposed between the junction box 60 and the battery control device 40, as described above. The battery control device 40 is disposed closer to the one end side of the blade cells 260 on which the battery monitoring devices 30 are disposed. The battery monitoring devices 30 and the battery control device 40 perform wireless communication using lateral spaces in the Y direction of the storage case 50 and spaces above the blade cells 260 as propagation paths of radio waves.

Providing the electrode terminals of the blade cells 260 and the bus bars 23 on a side opposite to a side on which the battery monitoring devices 30 are disposed in the Y direction (left side in FIG. 24) can suppress the influence of electromagnetic noise generated from the electrode terminals or the bus bars 23.

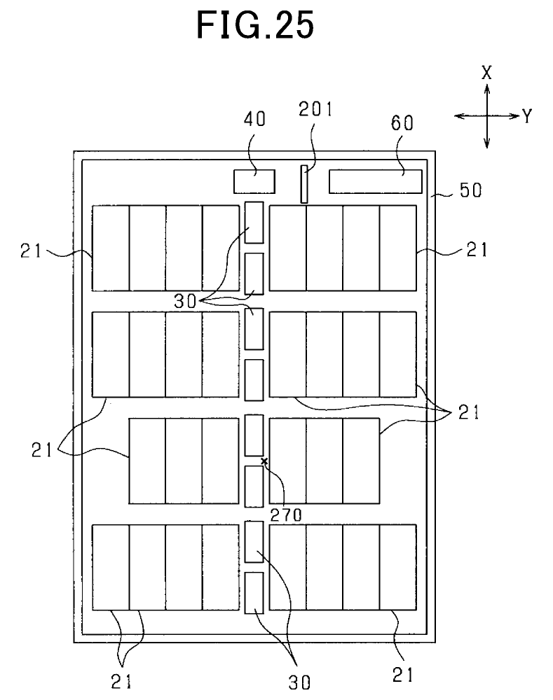

(2F) In the second embodiment and its modifications described above, as illustrated in FIG. 25, the battery blocks 21 may be arranged along the lateral direction (Y direction) so as to form multiple rows (four rows in FIG. 25) in the longitudinal direction (X direction) of the storage case 50. In this case, the battery cells 22 constituting each battery block 21 may be stacked in the Y direction such that their electrode terminals gather on one end side in the X direction.

Further, as illustrated in FIG. 25, a communication path 270 may be provided at a center in the Y direction of the storage case 50. The battery blocks 21 are arranged symmetrically with respect to the communication path 270. When the number of battery blocks 21 arranged in the Y direction is smaller in a certain row (as shown in the third row from the top in FIG. 25) than in other rows, the battery blocks 21 are disposed closer to the central communication path 270.

In FIG. 25, the battery monitoring devices 30 are disposed along the communication path 270. The battery control device 40 is disposed side by side with the junction box 60 in the Y direction at one end side in the X direction of the storage case 50. An electromagnetic shield 201 having a size sufficient to substantially cover a side surface of the junction box 60 or a side surface of the ECU case 45 is provided between the battery control device 40 and the junction box 60. It is preferable that the battery control device 40 is disposed closer to the communication path 270 than the junction box 60. In FIG. 25, the battery control device 40 is disposed on the communication path 270. The battery control device 40 and the battery monitoring devices 30 perform wireless communication using the communication path 270 as a propagation path of radio waves.

In the modification illustrated in FIG. 25, the electrode terminals of the battery cells 22 constituting the battery blocks 21 may preferably be provided on surfaces not facing the battery monitoring devices 30 or the battery control device 40, such as upper surfaces. This can suppress the influence of noise generated by the electrode terminals or the bus bars 23.

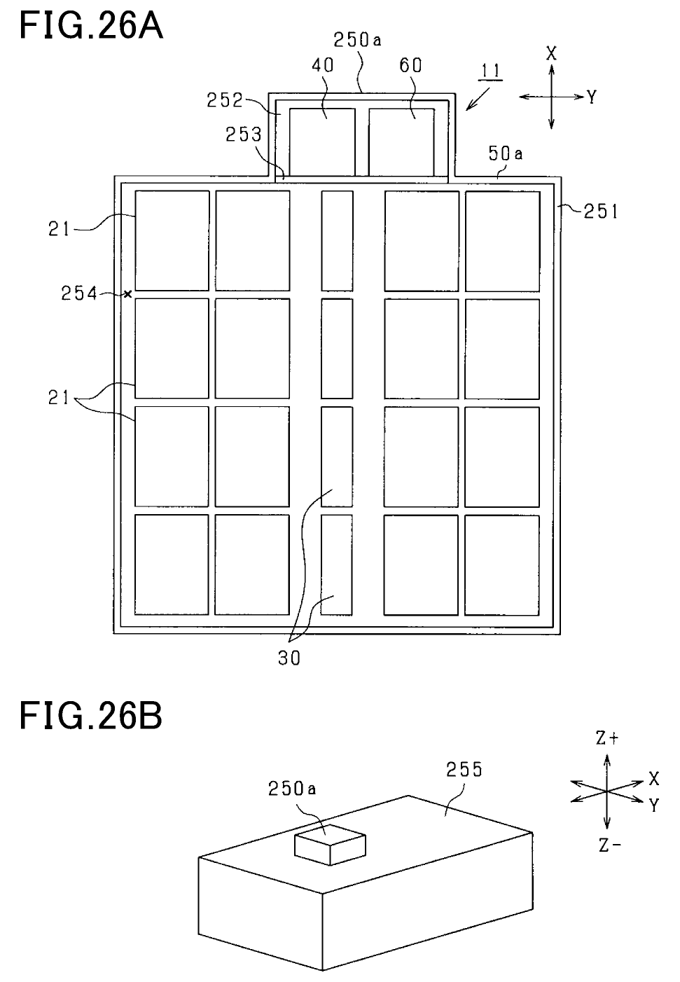

(2G) In the second embodiment and its modifications described above, shapes of the storage cases 50, 150, and 250 may be arbitrarily changed. For example, a storage case 251 illustrated in FIG. 26A has an accommodation space 252 in a protruding portion 250a that protrudes in the longitudinal direction from the side wall 50a. The battery control device 40 and the junction box 60 are accommodated in the accommodation space 252. An opening of the accommodation space 252 is closed by a partition plate 253 formed of a material that allows radio waves to pass (for example, resin), thereby separating it from a space 254 in which the battery blocks 21 are accommodated.

The battery control device 40 transmits (passes) radio waves through the partition plate 253 and performs wireless communication with the battery monitoring devices 30 disposed near the battery blocks 21. The junction box 60 may be enclosed by a metal case (electromagnetic shielding member).

The partition plate 253 of the accommodation space 252 may be formed of an electromagnetic shielding member. In this case, the electromagnetic shield 201 may be provided between the junction box 60 and the battery control device 40, and only the master-side wireless antenna 43 may be disposed in the space in which the battery blocks 21 are accommodated. Alternatively, a passage portion that allows radio waves to pass may be provided in the partition plate 253, and radio waves may be input and output through the passage portion.

As in a storage case 255 illustrated in FIG. 26B, the protruding portion 250a (that is, the accommodation space 252) may be provided on an upper surface instead of the side wall 50a.

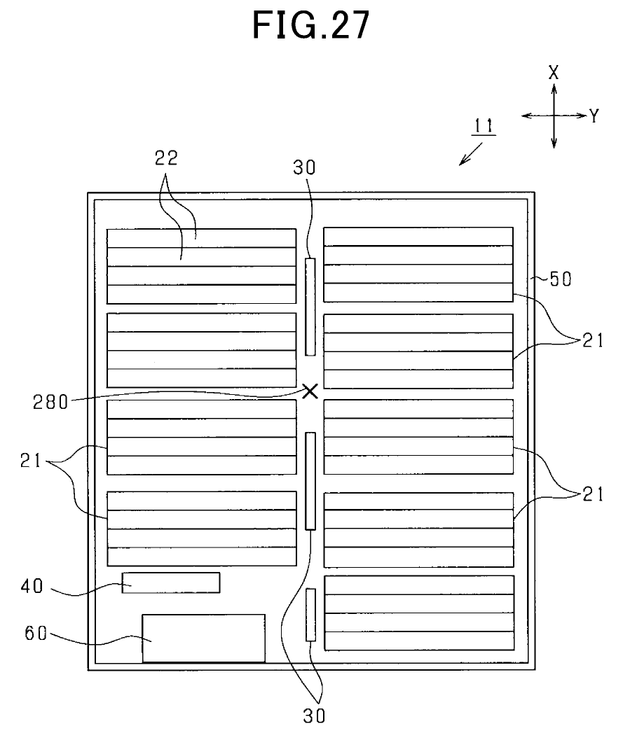

(2H) In the second embodiment and its modifications described above, the arrangement may be changed as illustrated in FIG. 27. The battery blocks 21 are aligned along the longitudinal direction (X direction) so as to form two rows in the lateral direction (Y direction) of the storage case 50. Each battery block 21 is configured by stacking a plurality of battery cells 22 in the X direction. Electrode terminals of each battery cell 22 are disposed on one or both sides in the Y direction and the plurality of battery cells 22 are connected to each other to form the battery block 21.

A central passage 280 is provided at a center in the Y direction, and a plurality of battery monitoring devices 30 are disposed in the central passage 280. In FIG. 27, the plurality of battery monitoring devices 30 are arranged vertically, but the orientation is arbitrary.

In FIG. 27, the number of battery blocks 21 in the left row is one less than that in the right row, and an accommodation space is provided at an end in the X direction. The battery control device 40 and the junction box 60 are disposed in the accommodation space. In the modification illustrated in FIG. 27, the junction box 60 includes a metal case (electromagnetic shielding member), but an electromagnetic shield may be provided so as to partition between the battery control device 40 and the battery monitoring devices 30.

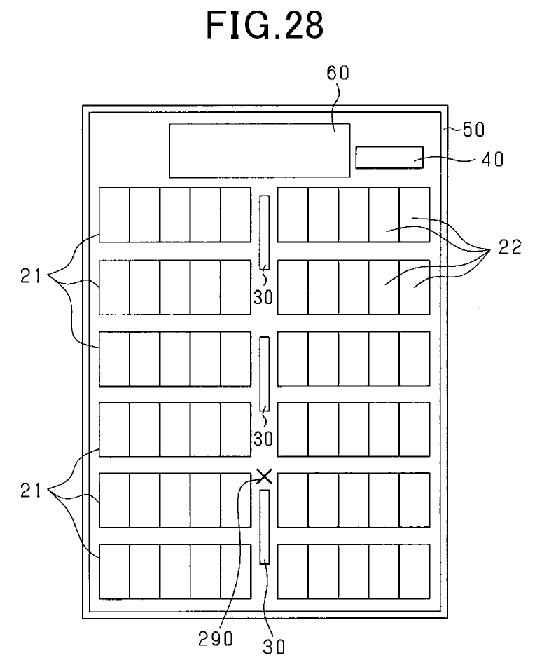

(2I) In the second embodiment and its modifications described above, the arrangement may be changed as illustrated in FIG. 28. The battery blocks 21 are aligned along the longitudinal direction (X direction) so as to form two rows in the lateral direction (Y direction) of the storage case 50. Each battery block 21 is configured by stacking a plurality of battery cells 22 in the Y direction. Electrode terminals of the battery cells 22 are provided on upper surfaces (Z+ direction) and are connected to each other to form the battery blocks 21.

A central passage 290 is provided at a center in the Y direction, and a plurality of battery monitoring devices 30 are disposed in the central passage 290. In FIG. 28, the plurality of battery monitoring devices 30 are arranged vertically, while the orientation is arbitrary.

In FIG. 28, the junction box 60 is disposed substantially at the center in the Y direction at one end in the X direction of the storage case 50. The battery control device 40 is disposed adjacent thereto. In the modification illustrated in FIG. 28, the junction box 60 includes a metal case (electromagnetic shielding member), thereby reducing leakage of electromagnetic noise to the outside. An electromagnetic shield may be provided so as to partition between the battery control device 40 and the battery monitoring devices 30. In FIG. 28, an upper space of the battery blocks 21 is used as a propagation path of radio waves.

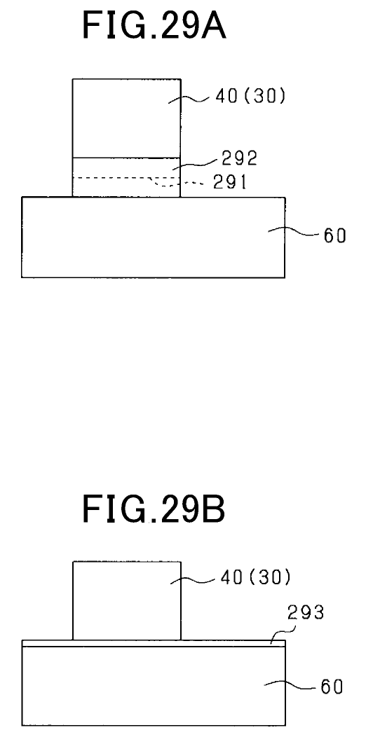

(2J) In the second embodiment and its modifications described above, a configuration of the electromagnetic shielding member may be arbitrarily changed. For example, as illustrated in FIG. 29A, a metal case 292 accommodating a circuit board 291 may be utilized as an electromagnetic shielding member interposed between the battery control device 40 (or the battery monitoring device 30) and the junction box 60 serving as a noise source. The circuit board 291 in FIG. 29A is, for example, a circuit board on which an abnormality monitoring device is mounted that detects a current value and commands current interruption when the detected value is abnormal.

(2K) In the second embodiment and its modifications described above, as illustrated in FIG. 29B, a heat dissipation plate 293 (conductor) employed in the junction box 60 may be used as an electromagnetic shielding member.

(2L) In the second embodiment and its modifications described above, the junction box 60 has been specified as a noise source. Alternatively, other elements may be specified as noise sources, and they may be partitioned by an electromagnetic shielding member. As noise sources other than the junction box 60, bus bars 23 or power supply terminals through which current may flow from an external electrical load may also be assumed. When bus bars 23 or power supply terminals are assumed as noise sources, the bus bars 23 or the power supply terminals may be covered with a metal case or the like. If an intensity of radiated electromagnetic noise exceeds a predetermined threshold, it may be regarded as a noise source.

(2M) In the embodiments and modifications described above, the electromagnetic shielding member is not limited to metal and may be something coated with conductive paint or formed of metal fibers. The electromagnetic shielding member may be made of metal having large reflection loss of electromagnetic waves, such as copper or aluminium, or metal having large absorption loss of electromagnetic waves, such as iron. Electromagnetic noise refers to noise in a frequency band of approximately 300 Hz to 3 THz that interferes with RF signals, but electromagnetic noise in other frequency bands may also be included.

(2N) In the second embodiment described above, the metal plates 37 and 47 serving as proximate conductors that are close to the antennas 33 and 43 and electrostatically coupled thereto may be omitted.

### Third Embodiment

A battery pack according to a third embodiment will now be described.

As described in the first embodiment, it is common that the battery pack 11 and the battery cells 22 are provided with an explosion-proof valve for releasing gas when an internal pressure (more specifically, a pressure difference between inside and outside) becomes equal to or greater than a specified value. Explosion-proof valves are described, for example, in JP 2020-074279 A. However, when wireless communication is performed, if gas is ejected from such an explosion-proof valve, there is a concern that the gas may affect the wireless communication.

The third embodiment is provided in view of the circumstances described above. One objective of the third embodiment is to provide a battery pack 11 (power supply unit) capable of suppressing interference with wireless communication even when gas is discharged from an explosion-proof valve.

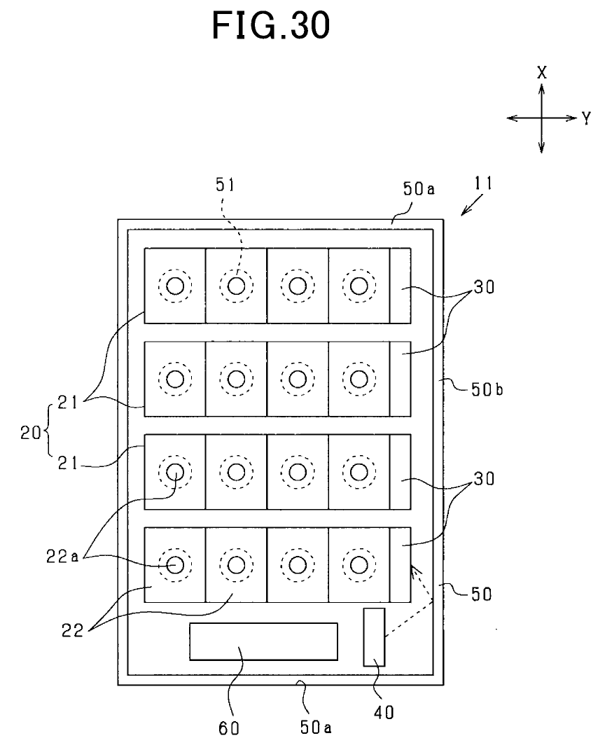

The battery pack 11 of the third embodiment will be described in detail below with reference to FIG. 30.

As illustrated in FIG. 30, a plurality of battery blocks 21 are arranged in a line in a longitudinal direction (X direction) of the storage case 50. The battery control device 40 and the junction box 60 are disposed between one side wall 50a in the X direction of the storage case 50 and a side surface of the assembled battery 20 (more specifically, the battery block 21 disposed at one end in the X direction). The battery control device 40 is disposed side by side with the junction box 60 in the Y direction. In FIG. 30, the battery control device 40 is disposed near the right-side wall 50b.

In the third embodiment, the cell explosion-proof valves 22a are provided on upper surfaces of the respective battery cells 22 as in the first embodiment (see FIG. 30), and the housing explosion-proof valves 51 are provided on the upper surface of the storage case 50 as in the first embodiment (indicated by broken lines). The housing explosion-proof valves 51 are provided at positions facing (overlapping) the respective cell explosion-proof valves 22a in the vertical direction, but the placement thereof can be arbitrarily changed. In addition, the size, number, and shape of each housing explosion-proof valve 51 can be arbitrarily changed. For example, a single large housing explosion-proof valve 51 may be provided at a central portion of the upper surface of the storage case 50. The battery control device 40 is arranged vertically, but the orientation is arbitrary.

On the other hand, as illustrated in FIG. 30, a plurality of battery monitoring devices 30 are disposed in a space provided between the right-side wall 50b in the Y direction and right-side surfaces of the respective battery blocks 21. The battery monitoring devices 30 are arranged vertically, but the orientation may be arbitrarily changed. The battery control device 40 and the battery monitoring devices 30 perform wireless communication using the space provided on the right side of the battery blocks 21 as a propagation path of radio waves (exemplified by broken lines).

The above embodiment achieves the following effects.

The cell explosion-proof valves 22a are provided on the upper surfaces of the respective battery cells 22. Accordingly, gas from the cell explosion-proof valves 22a is discharged upward from the battery blocks 21. Also, the housing explosion-proof valve 51 is provided on the upper surface of the storage case 50. Accordingly, gas discharged upward from the battery blocks 21 is discharged through the housing explosion-proof valve 51, resulting in a structure in which gas is less likely to be discharged to lateral sides of the battery blocks 21.

Meanwhile, the battery control device 40 and the battery monitoring devices 30 perform wireless communication using the space provided on the right side of the battery blocks 21 as the propagation path of radio waves. Thus, the propagation path of radio waves and the gas discharge path can be separated, thereby suppressing obstruction to wireless communication.

The battery control device 40 and the battery monitoring devices 30 are disposed laterally of the battery blocks 21. This can prevent gas from being directly ejected from the cell explosion-proof valves 22a toward the battery monitoring devices 30 or the battery control device 40. This can suppress failures of the battery monitoring devices 30 or the battery control device 40 due to the gas.

On the upper surface of the storage case 50, a region where the housing explosion-proof valves 51 are provided is, due to its structure, thinner than other portions of the storage case 50 such as side surfaces, and is more susceptible to intrusion of electromagnetic noise from outside. Therefore, the battery monitoring devices 30 and the battery control device 40 are provided at positions different from the positions where the housing explosion-proof valves 51 are provided, that is, at positions that do not overlap the region of the housing explosion-proof valves 51 in the vertical direction (Z direction). This can suppress the influence of external noise.

Further, the space provided on the right side of the battery blocks 21 is located at a position different from the positions where the housing explosion-proof valves 51 are provided, that is, at a position that does not overlap the region of the housing explosion-proof valves 51 in the vertical direction (Z direction). When wireless communication is performed using the space provided on the right side of the battery blocks 21 as the propagation path of radio waves, the influence of electromagnetic noise entering through the housing explosion-proof valves 51 can be suppressed.

Further, the housing explosion-proof valves 51 face the upper surfaces of the battery cells 22, and the battery monitoring devices 30 and the battery control device 40 are not disposed between the housing explosion-proof valves 51 and the battery cells 22. Accordingly, electromagnetic noise that has entered from outside through the housing explosion-proof valves 51 is reflected by the battery cells 22 (battery cases thereof), making it easier to be radiated back to the outside through the housing explosion-proof valves 51. This allows the battery cells 22 to block paths through which electromagnetic noise enters from outside through the housing explosion-proof valves 51, thereby suppressing interference with wireless communication.

### Modifications of Third Embodiment

Modifications in which part of the configuration of the battery pack 11 in the third embodiment is changed will be described below.

(3A) In the above embodiment and modifications, the cell explosion-proof valves 22a may be provided on side surfaces of the battery cells 22. Alternatively, the cell explosion-proof valves 22a may be provided on any of side surfaces in the X direction or side surfaces in the Y direction. In this case, the battery monitoring devices 30 and the battery control device 40 may be arranged so as to face a side surface on which the cell explosion-proof valves 22a are not provided. Alternatively, the battery monitoring devices 30 and the battery control device 40 may be disposed on any of the upper surfaces of the battery cells 22.

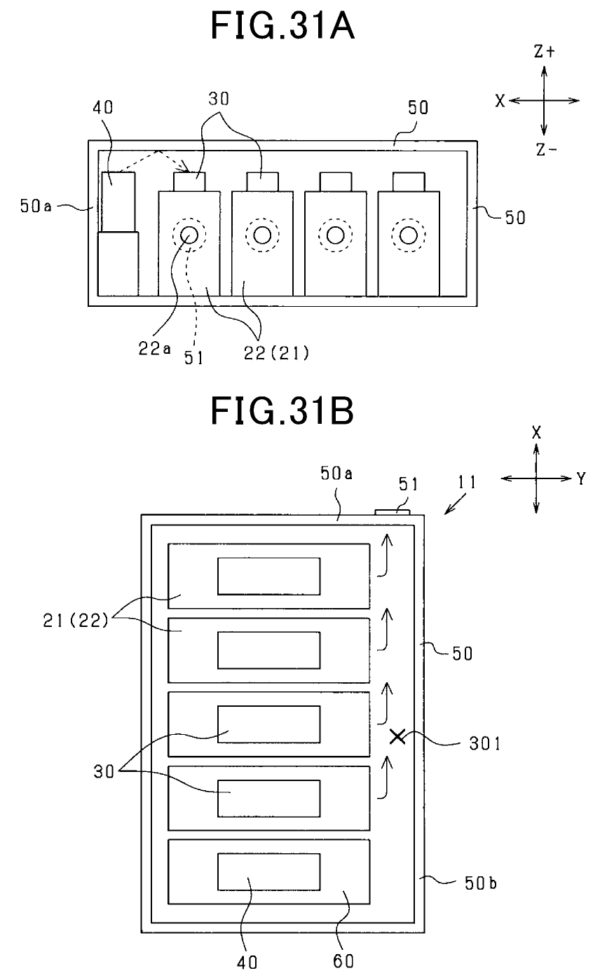

For example, a case will be described in which, as illustrated in FIG. 31A, when the battery cells 22 are arranged in a line in the X direction, the cell explosion-proof valves 22a are provided on one side surface of the respective battery cells 22 in the Y direction (in FIG. 31A, the side surface on the near side of the drawing). In this case, as illustrated in FIG. 31A, the battery monitoring devices 30 may be disposed on the upper surfaces of the battery cells 22, and the battery control device 40 may be disposed adjacent to a side surface of the battery cells 22 in the X direction. That is, it is sufficient that the battery monitoring devices 30 and the battery control device 40 are not disposed at positions facing the cell explosion-proof valves 22a. Although not illustrated, the battery monitoring devices 30 and the battery control device 40 may be disposed on the opposite side surface of the battery cells 22 in the Y direction (the side surface on which the cell explosion-proof valves 22a are not provided).

(3B) In the above embodiment and modifications, it is preferable that the housing explosion-proof valves 51 are provided on a surface facing a surface on which the cell explosion-proof valves 22a are disposed. More preferably, the housing explosion-proof valves 51 are provided at positions facing the cell explosion-proof valves 22a. In that case, it is preferable that there is no obstruction between the cell explosion-proof valves 22a and the housing explosion-proof valves 51.

For example, as illustrated in FIG. 31A, when the cell explosion-proof valves 22a are provided on side surfaces of the battery cells 22, the housing explosion-proof valves 51 (indicated by broken lines) may be provided on a side wall of the storage case 50 facing the cell explosion-proof valves 22a.

As illustrated in FIG. 31B, when the interior of the battery pack 11 is viewed from above, a gap between the right-side surface of each battery cell 22 and the right-side wall 50b of the storage case 50 may serve as a gas discharge passage 301. The gas discharge passage 301 is formed to extend in the X direction. The housing explosion-proof valve 51 may be provided on the side wall 50a of the storage case 50 at which the gas discharge passage 301 terminates in the X direction. With this configuration, gas discharged from the right-side surfaces of the battery cells 22 passes through the gas discharge passage 301 and is discharged to the outside through the housing explosion-proof valve 51 provided on the side wall 50a in the X direction of the storage case 50. Providing the housing explosion-proof valve 51 on the side wall 50a opposite to the battery control device 40 in the X direction can suppress accumulation of gas around the battery control device 40.

(3C) In the above embodiment and modifications, the battery monitoring devices 30 and the battery control device 40 may be disposed so as to face a surface on which the cell explosion-proof valves 22a are provided. In this case, the battery monitoring devices 30 and the battery control device 40 are disposed at different positions so as not to face the cell explosion-proof valves 22a.

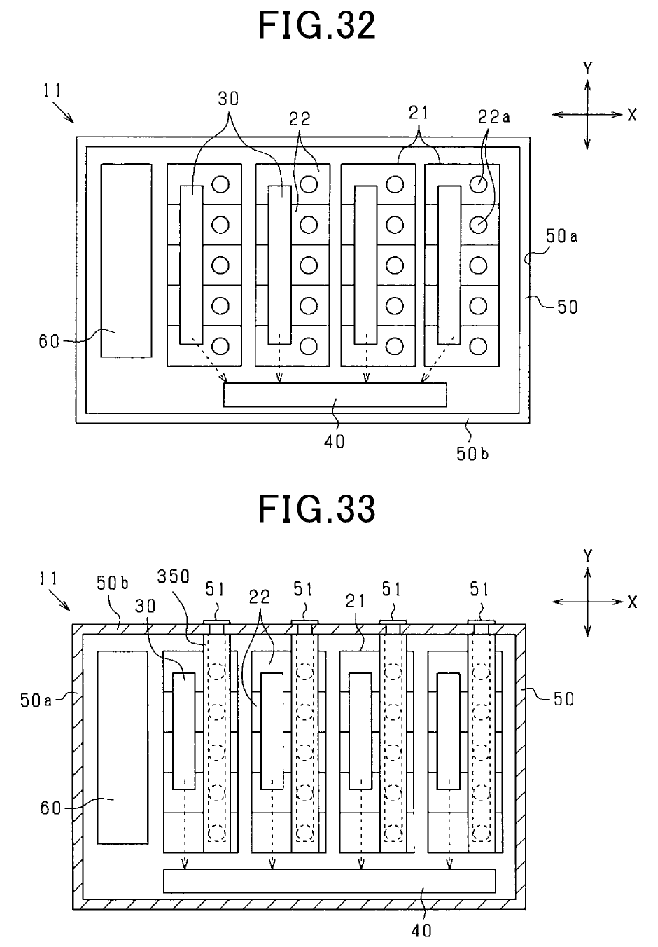

This will now be described in detail with reference to FIG. 32. In FIG. 32, a plurality of battery blocks 21 are arranged in the X direction. In each battery block 21, a plurality of battery cells 22 are arranged in the Y direction, and the cell explosion-proof valves 22a are provided on the upper surfaces of the respective battery cells 22 on one side in the X direction (right side in FIG. 32).

The battery monitoring device 30 is disposed on the upper surface of each battery cell 22 on the other side in the X direction (left side in FIG. 32). That is, the battery monitoring device 30 is provided on the upper surface of the battery cell 22 at a position different from the cell explosion-proof valve 22a (a position that does not face the cell explosion-proof valve 22a and does not overlap in the Z direction (vertical direction)). As illustrated in FIG. 32, the battery monitoring device 30 may be disposed across a plurality of battery cells 22. In FIG. 32, the battery control device 40 is disposed laterally of the battery blocks 21 in the Y direction. Accordingly, even when gas is discharged from the cell explosion-proof valves 22a, it is possible to prevent the gas from being directly ejected to the battery monitoring devices 30 or the battery control device 40.

The housing explosion-proof valves 51 of the storage case 50 are provided on the upper surface of the storage case 50 substantially directly above the respective cell explosion-proof valves 22a (not illustrated). Accordingly, gas is discharged above the battery cells 22, thereby preventing obstruction of the radio wave propagation path. An example of the propagation path of radio waves is indicated by broken lines in FIG. 32.

(3D) In the above embodiment and modifications, the cell explosion-proof valves 22a and the housing explosion-proof valves 51 may be provided on a lower surface (Z− surface) of the storage case 50. In this case, the battery monitoring devices 30 and the battery control device 40 may be provided above or laterally of the battery blocks 21, that is, at positions other than below the battery blocks 21. With this configuration, the propagation path of radio waves and the gas discharge path can be separated. This can prevent gas from being directly ejected from the cell explosion-proof valves 22a toward the battery monitoring devices 30 or the battery control device 40.

(3E) In the above embodiment and modifications, an exhaust duct for guiding gas discharged from the cell explosion-proof valves 22a of the battery cells 22 to the housing explosion-proof valve 51 of the storage case 50 may be provided. It is preferable that the exhaust duct is provided so as not to interfere with (not cross) the propagation path of radio waves.

This will now be described in detail with reference to FIG. 33. In the modification of FIG. 33, a plurality of battery blocks 21 are arranged in the X direction. In each battery block 21, a plurality of battery cells 22 are arranged in the Y direction, and the cell explosion-proof valves 22a are provided on the upper surfaces of the respective battery cells 22 on one side in the X direction (right side in FIG. 33). In FIG. 33, the cell explosion-proof valves 22a are indicated by broken lines.

The battery monitoring device 30 is disposed on the upper surfaces of the battery cells 22 on the other side in the X direction (left side in FIG. 33). That is, the battery monitoring device 30 is provided on the upper surfaces of the battery cells 22 at a position different from the cell explosion-proof valves 22a (a position that does not face the cell explosion-proof valve 22a and does not overlap in the Z direction). In FIG. 33, the battery control device 40 is disposed laterally of the battery block 21 in the Y direction.

The exhaust duct 350 is configured in a tubular shape extending linearly in the Y direction, and is disposed directly above the respective cell explosion-proof valves 22a in the vertical direction. The exhaust duct 350 is generally formed of metal. The exhaust duct 350 is provided for each battery block 21 and extends across the cell explosion-proof valves 22a of the plurality of battery cells 22 constituting the battery block 21. In the modification illustrated in FIG. 32, for each battery block 21, the exhaust duct 350 is provided so as to cover the cell explosion-proof valves 22a of all the battery cells 22 constituting the battery block 21.

The exhaust duct 350 is provided with through holes at positions corresponding to the cell explosion-proof valves 22a. When the cell explosion-proof valves 22a are opened, an interior of the battery cells 22 communicates with the exhaust duct 350 through the through holes. Accordingly, gas discharged from the cell explosion-proof valves 22a is discharged into the exhaust duct 350. The exhaust duct 350 is formed to extend toward the housing explosion-proof valve 51 provided on the side wall 50b of the storage case 50, and is open at a position corresponding to the housing explosion-proof valve 51. That is, in the Y direction, the housing explosion-proof valve 51 side end of the exhaust duct 350 is open and is connected to the housing explosion-proof valve 51. Therefore, gas that has passed through the exhaust duct 350 is discharged to the outside through the housing explosion-proof valve 51. In the Y direction, an end of the exhaust duct 350 opposite to the housing explosion-proof valve 51 is closed.

Meanwhile, for each battery block 21, the battery monitoring device 30 is disposed on the upper surfaces of the battery cells 22 constituting the battery block 21 on the other side in the X direction (left side in FIG. 33). That is, the battery monitoring device 30 is provided on the upper surfaces of the battery cells 22 at a position that does not interfere with the exhaust duct 350. In FIG. 33, the battery control device 40 is disposed laterally of the battery blocks 21 in the Y direction and on a side opposite to the housing explosion-proof valves 51. Accordingly, even when gas is discharged from the cell explosion-proof valves 22a, it is possible to prevent the gas from being directly ejected to the battery monitoring device 30 or the battery control device 40.

A propagation path of radio waves between the battery control device 40 and each battery monitoring device 30 is set so as not to intersect the exhaust duct 350. For example, a propagation path indicated by a broken-line arrow in FIG. 33 is parallel to the exhaust duct 350. Accordingly, the gas does not obstruct the propagation path, enabling preferable wireless communication.

Further, the exhaust duct 350 is provided so as to extend to the housing explosion-proof valve 51 provided on the side wall 50b of the storage case 50. The exhaust duct 350 is made of metal. Therefore, even when the housing explosion-proof valve 51 is opened and electromagnetic noise from outside becomes more likely to enter, the housing explosion-proof valve 51 is covered by the metal exhaust duct 350, thereby preventing the electromagnetic noise from leaking to an outside of the exhaust duct 350. That is, the exhaust duct 350 can function as an electromagnetic shield that blocks electromagnetic noise entering through the housing explosion-proof valve 51. This can suppress the influence of external electromagnetic noise on the battery control device 40, the battery monitoring devices 30, and the like disposed outside the exhaust duct 350.

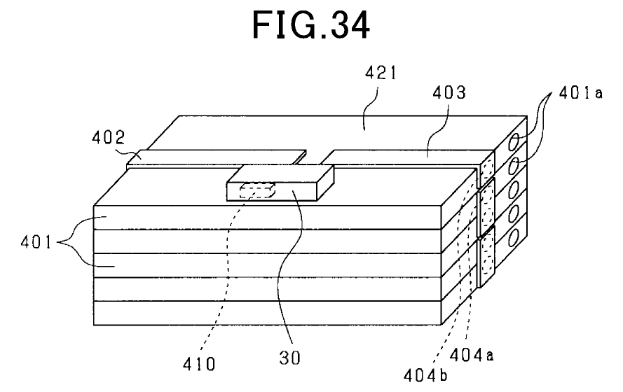

(3F) In the above embodiment and modifications, the battery cells 22 may be configured as long plate-shaped blade cells. In this case, for example, as illustrated in FIG. 34, a battery block 421 is configured by stacking a plurality of blade cells 401 in a predefined direction (Z direction or vertical direction in FIG. 34). In the blade cell 401 of FIG. 34, a positive electrode terminal 404a is provided at one end in a longitudinal direction, and a negative electrode terminal 404b is provided at the other end. Accordingly, the battery monitoring device 30 is disposed at a longitudinal center of the blade cell 401, and a positive-side detection line 402 and a negative-side detection line 403 are respectively extended from the longitudinal center to both sides in the longitudinal direction and are connected to the respective electrode terminals 404a and 404b. This can make wiring resistance of the positive-side detection line 402 connected to the positive electrode side equal to wiring resistance of the negative-side detection line 403 connected to the negative electrode side, thereby preventing deterioration of detection accuracy.

In FIG. 34, the battery monitoring device 30, the positive-side detection line 402, and the negative-side detection line 403 are provided on an upper surface of the battery block 421. The positive-side detection line 402 and the negative-side detection line 403 are provided near a middle in a width direction (direction orthogonal to the longitudinal direction) of the battery block 421. Meanwhile, the battery monitoring device 30 is disposed offset from the positive-side detection line 402 and the negative-side detection line 403 in the width direction.

A wireless circuit 410 (indicated by broken lines) included in the battery monitoring device 30 is provided, in the monitoring circuit board 34, on a side opposite to connection positions of the positive-side detection line 402 and the negative-side detection line 403 in the width direction. That is, the wireless circuit 410 is disposed at a position as far as possible from the positive-side detection line 402 and the negative-side detection line 403, which are noisy. The wireless circuit 410 refers to circuit elements related to wireless communication and includes the slave-side wireless antenna 33, the slave-side wireless IC 32, a front-end circuit, and the like.

In FIG. 34, an explosion-proof valve 401a of each blade cell 401 is provided on an end surface in the longitudinal direction. This can prevent gas from the explosion-proof valves 401a from being directly ejected to the battery monitoring device 30 disposed on the upper surface of the battery block 421. This can suppress intrusion of gas into the propagation path of radio waves.

(3G) In the third embodiment described above, the metal plates 37 and 47 serving as proximate conductors that are close to the antennas 33 and 43 and electrostatically coupled thereto may be omitted. Also, in the third embodiment described above, an electromagnetic shielding member that blocks electromagnetic noise from a noise source disposed in the battery accommodation space, such as the electromagnetic shield 201, may be omitted.

The above embodiments and their modifications may be combined and used where compatible.

For example, in the battery monitoring devices 30 and the battery control device 40 described in the second embodiment (and its modifications; the same applies below) and the third embodiment (and its modifications; the same applies below), an internal structure of the battery monitoring devices 30 or the battery control device 40 of the first embodiment (and its modifications), specifically, the structures of the antennas 33 and 43 and the metal plates 37 and 47, may be adopted.

Also, the modes and placements of the housing explosion-proof valve 51 and the cell explosion-proof valves 22a described in the third embodiment may be appropriately adopted in the storage case 50 and the battery cells 22 of the first embodiment (and its modifications; the same applies below) or the second embodiment. For example, in the first embodiment or the second embodiment, similarly to the third embodiment, a configuration can naturally be derived in which the cell explosion-proof valves 22a are provided on upper surfaces or side surfaces of the battery cells 22 and the housing explosion-proof valve 51 is provided on an upper surface (a central portion of the upper surface) or a side surface of the storage case 50.

Also, in the first embodiment or the second embodiment, similarly to the third embodiment, the housing explosion-proof valves 51 and the cell explosion-proof valves 22a may be disposed so as to avoid the propagation path of radio waves between the battery monitoring device 30 and the battery control device 40. Also, in the first embodiment or the second embodiment, similarly to the third embodiment, the battery monitoring devices 30 (or the battery control device 40) may be disposed to avoid the housing explosion-proof valves 51 and the cell explosion-proof valves 22a.

In the first or second embodiment, as in the third embodiment, configurations for suppressing interference with wireless communication caused by discharged gas, such as the gas discharge passage 301 and the exhaust duct 350, may be employed.

In addition, all of the first embodiment, the second embodiment, and the third embodiment may be combined.

Characteristic configurations extracted from the above-described embodiments will be described below.

### Configuration 1

A wireless device in a battery monitoring system (100), the wireless device comprising:

a wireless antenna (33, 43); and

a proximate conductor (37, 47) that overlaps at least a portion of a projection plane of the wireless antenna in a predefined projection direction.

### Configuration 2

The wireless device according to configuration 1, further comprising a circuit board (34, 44) on which the wireless antenna is mounted, wherein

the proximate conductor is disposed closest to the wireless antenna among conductors other than a conductor mounted on the circuit board.

### Configuration 3

The wireless device according to claim 2, wherein

the predefined direction is a direction perpendicular to the circuit board.

### Configuration 4

The wireless device according to any one of configurations 1 to 3, wherein

the projection plane of the wireless antenna in the predefined direction is a projection plane with a maximum projected area as compared with projection planes in other directions.

### Configuration 5

The wireless device according to any one of configurations 2 to 4, wherein

the proximate conductor is plate-shaped, and a planar surface of the proximate conductor faces the circuit board.

### Configuration 6

The wireless device according to configuration 2 or 3, wherein

the wireless antenna comprises:

an element (33a, 43a) configured to radiate radio waves; and

a wiring pattern (33b, 43b) disposed to face the element, wherein

the wiring pattern has a potential corresponding to a reference potential of the circuit board, and

in the circuit board, the proximate conductor is disposed on a side opposite to a side on which the element is disposed.

### Configuration 7

The wireless device according to configuration 6, further comprising a wireless IC (32, 42) connected to the wireless antenna, wherein,

in the circuit board, the wireless IC is disposed on a surface opposite to a surface on which the element is disposed, and

the proximate conductor is configured to cover the wireless IC.

### Configuration 8

The wireless device according to any one of configurations 1 to 7, wherein,

in the predefined direction, an entire projection plane of the wireless antenna overlaps the proximity conductor.

### Configuration 9

The wireless device according to any one of configurations 1 to 8, wherein

the proximate conductor constitutes a portion of a housing of the wireless device.

### Configuration 10

The wireless device according to any one of configurations 1 to 9, wherein

a housing of the wireless device is provided with a radio-wave transmission portion that permits radio waves radiated from the wireless antenna to pass through the housing.

### Configuration 11

The wireless device according to configuration 10, wherein

the radio-wave transmission portion is provided on a side closer to a communication partner than the wireless antenna in a propagation path of the radio waves, and is provided on a side opposite to the proximate conductor with reference to the wireless antenna.

### Configuration 12

The wireless device according to configuration 10 or 11, wherein,

in a direction perpendicular to the predetermined direction, a width dimension of the passage portion is equal to or greater than one-half of a wavelength of radio waves radiated from the wireless antenna.

### Configuration 13

The wireless device according to any one of configurations 10 to 12, wherein,

in the predefined direction, on a side of the wireless antenna opposite the proximate conductor, no conductor is present, or, when a conductor is present, a distance between the conductor and the wireless antenna is equal to or greater than one-half of a wavelength of radio waves radiated from the wireless antenna.

### Configuration 14

The wireless device according to configuration 13, wherein,

in the predefined direction, a distance between the housing of the wireless device and the wireless antenna is equal to or greater than one-half of a wavelength of radio waves radiated from the wireless antenna.

### Configuration 15

The wireless device according to any one of configurations 1 to 14, wherein

the wireless antenna comprises:

an element (33a, 43a) configured to radiate radio waves; and

a wiring pattern (33b, 43b) disposed to face the element, wherein

the wiring pattern has a potential corresponding to a reference potential of a circuit board on which the wireless antenna is mounted,

the wiring pattern has a comb-teeth shape or a meander shape, and

the projection plane of the wireless antenna includes at least an entirety of a projection plane of the element and an entirety of a projection plane of the wiring pattern.

### Configuration 16

The wireless device according to any one of configurations 1 to 15, wherein the wireless antenna comprises:

an element (33a, 43a) configured to radiate radio waves; and

a wiring pattern (33b, 43b) disposed to face the element, wherein

the wiring pattern has a potential corresponding to a reference potential of a circuit board on which the wireless antenna is mounted,

the element has at least one of a comb shape, an L shape, and a stub shape, and

the projection plane of the wireless antenna includes at least an entirety of a projection plane of the element and an entirety of a projection plane of the wiring pattern.

### Configuration 17

The wireless device according to any one of configurations 1 to 16, further comprising an insulating sheet (36, 46) between the wireless antenna and the proximate conductor.

### Configuration 18

The wireless device according to any one of configurations 1 to 7, wherein

a capacitance generated between the proximate conductor and the wireless antenna is larger than a capacitance generated between another conductor and the wireless antenna.

### Configuration 19

A power supply unit (11) comprising:

a plurality of wireless devices (30, 40) each being the wireless device according to any one of configurations 1 to 18; and

a battery section (20, 21, 22), the power supply unit being configured to transmit and receive battery information by wireless communication between the plurality of wireless devices, wherein

the power supply unit comprises a noise source (60) configured to generate electromagnetic noise,

the plurality of wireless devices and the noise source are both disposed in a battery accommodating space of the power supply unit, and

an electromagnetic shielding member (201) is interposed between the wireless devices and the noise source.

### Configuration 20

The power supply unit according to configuration 20, wherein

a housing (35, 45) of each wireless device is provided with a radio-wave transmission portion that permits radio waves to pass through the housing, and

the radio-wave transmission portion is provided on a side closer to a communication partner than the wireless antenna (33, 43) in a propagation path of the radio waves, and is provided, with reference to the wireless antenna, on a side opposite to the noise source.

### Configuration 21

The power supply unit of configuration 19 or 20, wherein,

among surfaces of the housing of each wireless device, a surface located on a noise-source side constitutes the electromagnetic shielding member.

### Configuration 22

The power supply unit according to any one of configurations 19 to 21, wherein

each wireless device comprises a directional antenna configured to radiate directional radio waves, and

the antenna is oriented such that a relatively high-intensity radiation direction is toward a communication partner and away from the noise source.

### Configuration 23

The power supply unit according to configuration 22, wherein

the antenna is oriented such that a relatively high-intensity radiation direction is away from the electromagnetic shielding member.

### Configuration 24

The power supply unit according to configuration 22 or 23, wherein

a housing of the wireless device is disposed adjacent to any battery cell of the battery section or adjacent to a side wall that partitions a battery accommodating space, and

the antenna is oriented such that a relatively high-intensity radiation direction is away from the battery cell and the side wall.

### Configuration 25

The power supply unit according to any one of configurations 19 to 24, wherein

the battery section comprises a plurality of battery cells (22),

the noise source is a junction box (60) having one or more relay switches (61) configured to switch between energization and interruption of energization in the battery section, the wireless devices comprise:

a battery monitoring device (30) provided for one or more battery cells, configured to acquire and transmit battery information; and

a battery control device (40) configured to receive the battery information from the battery monitoring device,

the battery control device is disposed closer to the junction box than the battery monitoring device, acquires a total voltage of the battery section from the junction box, and

the electromagnetic shielding member is provided between the battery control device and the junction box.

### Configuration 26

The power supply unit according to configuration 25, wherein, in the battery accommodating space, the battery control device is disposed above the junction box and performs communication by reflecting radio waves off a ceiling surface of the battery accommodating space.

### Configuration 27

The power supply unit according to any one of configurations 19 to 26, further comprising a case that accommodates the battery section and the wireless devices, wherein

the noise source is fixed to an outer surface of the case, and

a surface of the case to which the noise source is fixed serves as the electromagnetic shielding member.

### Configuration 28

A power supply unit (11) comprising:

a plurality of wireless devices (30, 40), each being a wireless device of any one of configurations 1 to 18; and

a battery section (20, 21, 22), wherein

the power supply unit is configured to transmit and receive battery information by wireless communication between the wireless devices,

the battery section includes an explosion-proof valve (22a), and

the explosion-proof valve is positioned to avoid a propagation path of radio waves radiated from the wireless devices.

### Configuration 29

The power supply unit according to configuration 28, wherein

the wireless devices are positioned such that none of the wireless devices faces the explosion-proof valve.

### Configuration 30

The power supply unit according to configuration 28 or 29, wherein

the explosion-proof valve is disposed on a side surface, an upper surface, or a bottom surface of the battery section, and

the wireless devices are positioned to face a surface other than a surface on which the explosion-proof valve is disposed.

### Configuration 31

The power supply unit according to any one of configurations 28 to 30, further comprising a storage case (50) that accommodates the wireless devices and the battery section, wherein

the storage case has an opening (51) configured to open in response to internal pressure of the storage case, and

the opening is positioned to face the explosion-proof valve.

### Configuration 32

The power supply unit according to configuration 31, wherein

the opening is disposed on an upper surface of the storage case, and

the wireless devices are positioned outside a region between the battery section and the upper surface of the storage case.

### Configuration 33

The power supply unit according to any one of configurations 28 to 32, further comprising a storage case that accommodates the wireless devices and the battery section, wherein

the storage case has an opening configured to open in response to internal pressure of the storage case,

the opening is positioned so as not to face the explosion-proof valve,

a smoke exhaust path through which gas discharged from the explosion-proof valve passes to the opening is defined, and

the wireless devices are positioned to avoid the smoke exhaust path.

### Configuration 34

The power supply unit according to configuration 33, wherein

the explosion-proof valve is provided laterally of the battery section,

the opening is provided on a side wall of the storage case,

the smoke exhaust path is formed between a lateral side of the battery section and the side wall of the storage case,

the wireless devices are disposed above the battery section, and

the propagation path is above the battery section.

### Configuration 35

The power supply unit according to configuration 33 or 34, wherein

the battery section faces the opening, and

none of the wireless devices and no propagation path are positioned between the opening and the battery section.

### Configuration 36

The power supply unit according to any one of configurations 28 to 35, further comprising a smoke exhaust duct through which gas discharged from the explosion-proof valve passes, wherein

the wireless devices are positioned away from the smoke exhaust duct.

### Configuration 37

The power supply unit according to configuration 36, wherein

the smoke exhaust duct is arranged parallel to the propagation path.

### Configuration 38

The power supply unit according to configuration 36 or 37, wherein,

upon opening of the explosion-proof valve, a port of the explosion-proof valve communicates with an interior of the smoke exhaust duct.

### Configuration 39

The power supply unit according to any one of configurations 36 to 38, further comprising a storage case that accommodates the wireless devices and the battery section, wherein

the storage case has an opening configured to open in response to internal pressure,

the smoke exhaust duct is a metal pipe, and

the interior of the opening is in communication with the interior of the smoke exhaust duct.

### Configuration 201

A power supply unit (11) comprising:

a battery section (20, 21, 22);

a plurality of wireless devices (30, 40) each being the wireless device according to any one of configurations 1 to 7; and

a noise source (60) configured to generate electromagnetic noise,

the plurality of wireless devices and the noise source are both disposed in a battery accommodating space of the power supply unit, and

an electromagnetic shielding member (201) is interposed between the wireless devices and the noise source.

### Configuration 202

The power supply unit according to configuration 201, wherein

a housing (35, 45) of each wireless device is provided with a radio-wave transmission portion that permits radio waves to pass through the housing, and

the radio-wave transmission portion is provided on a side closer to a communication partner than the wireless antenna (33, 43) in a propagation path of the radio waves, and is provided, with reference to the wireless antenna, on a side opposite to the noise source.

### Configuration 203

The power supply unit of configuration 201 or 202, wherein,

among surfaces of the housing of each wireless device, a surface located on a noise-source side constitutes the electromagnetic shielding member.

### Configuration 204

The power supply unit according to any one of configurations 201 to 203, wherein

each wireless device comprises a directional antenna configured to radiate directional radio waves, and

the antenna is oriented such that a relatively high-intensity radiation direction is toward a communication partner and away from the noise source.

### Configuration 205

The power supply unit according to configuration 204, wherein

the antenna is oriented such that a relatively high-intensity radiation direction is away from the electromagnetic shielding member.

### Configuration 206

The power supply unit according to configuration 204 or 205, wherein

a housing of the wireless device is disposed adjacent to any battery cell of the battery section or adjacent to a side wall that partitions a battery accommodating space, and

the antenna is oriented such that a relatively high-intensity radiation direction is away from the battery cell and the side wall.

### Configuration 207

The power supply unit according to any one of configurations 201 to 206, wherein

the battery section comprises a plurality of battery cells (22),

the noise source is a junction box (60) having one or more relay switches (61) configured to switch between energization and interruption of energization in the battery section, the wireless devices comprise:

a battery monitoring device (30) provided for one or more battery cells, configured to acquire and transmit battery information; and

a battery control device (40) configured to receive the battery information from the battery monitoring device,

the battery control device is disposed closer to the junction box than the battery monitoring device, acquires a total voltage of the battery section from the junction box, and

the electromagnetic shielding member is provided between the battery control device and the junction box.

### Configuration 208

The power supply unit according to configuration 207, wherein, in the battery accommodating space, the battery control device is disposed above the junction box and performs communication by reflecting radio waves off a ceiling surface of the battery accommodating space.

### Configuration 209

The power supply unit according to configuration 201, further comprising a case that accommodates the battery section and the wireless devices, wherein

the noise source is fixed to an outer surface of the case, and

a surface of the case to which the noise source is fixed serves as the electromagnetic shielding member.

### Configuration 301

A power supply unit (11) comprising:

a battery section (22);

a plurality of wireless devices (30, 40) configured to transmit and receive battery information by wireless communication between the plurality of wireless devices,

the battery section includes an explosion-proof valve (22a), and

the explosion-proof valve is positioned to avoid a propagation path of radio waves radiated from the wireless devices.

### Configuration 302

The power supply unit according to configuration 301, wherein

the wireless devices are positioned such that none of the wireless devices faces the explosion-proof valve.

### Configuration 303

The power supply unit according to configuration 201 or 302, wherein

the explosion-proof valve is disposed on a side surface, an upper surface, or a bottom surface of the battery section, and

the wireless devices are positioned to face a surface other than a surface on which the explosion-proof valve is disposed.

### Configuration 304

The power supply unit according to any one of configurations 301 to 303, further comprising a storage case (50) that accommodates the wireless devices and the battery section, wherein

the storage case has an opening (51) configured to open in response to internal pressure of the storage case, and

the opening is positioned to face the explosion-proof valve.

### Configuration 305

The power supply unit according to configuration 304, wherein

the opening is disposed on an upper surface of the storage case, and

the wireless devices are positioned outside a region between the battery section and the upper surface of the storage case.

### Configuration 306

The power supply unit according to any one of configurations 301 to 305, further comprising a storage case that accommodates the wireless devices and the battery section, wherein

the storage case has an opening configured to open in response to internal pressure of the storage case,

the opening is positioned so as not to face the explosion-proof valve,

a smoke exhaust path through which gas discharged from the explosion-proof valve passes to the opening is defined, and

the wireless devices are positioned to avoid the smoke exhaust path.

### Configuration 307

The power supply unit according to configuration 306, wherein

the explosion-proof valve is provided laterally of the battery section,

the opening is provided on a side wall of the storage case,

the smoke exhaust path is formed between a lateral side of the battery section and the side wall of the storage case,

the wireless devices are disposed above the battery section, and

the propagation path is above the battery section.

### Configuration 308

The power supply unit according to any one of configurations 304 to 307, wherein

the battery section faces the opening, and

none of the wireless devices and no propagation path are positioned between the opening and the battery section.

### Configuration 309

The power supply unit according to any one of configurations 301 to 308, further comprising a smoke exhaust duct (350) through which gas discharged from the explosion-proof valve passes, wherein

the wireless devices are positioned away from the smoke exhaust duct.

### Configuration 310

The power supply unit according to configuration 309, wherein

the smoke exhaust duct is arranged parallel to the propagation path.

### Configuration 311

The power supply unit according to configuration 309 or 310, wherein,

upon opening of the explosion-proof valve, a port of the explosion-proof valve communicates with an interior of the smoke exhaust duct.

### Configuration 312

The power supply unit according to any one of configurations 309 to 311, further comprising a storage case (50) that accommodates the wireless devices and the battery section, wherein

the storage case has an opening (51) configured to open in response to internal pressure,

the smoke exhaust duct is a metal pipe, and

the interior of the opening is in communication with the interior of the smoke exhaust duct.

The present disclosure has been described in accordance with examples, but it is understood that the present disclosure should not be limited to the examples and configurations. The present disclosure encompasses various modified examples and modifications within equivalent ranges. In addition, various combinations and forms as well as other combinations and forms including one or more/less constituents thereto are also within the scope and spirit of the present disclosure.

What is claimed is:

1. A wireless device removably mounted in a storage case of a battery monitoring system, the wireless device comprising:
a wireless antenna;
a proximate conductor that overlaps at least a portion of a projected surface of the wireless antenna in a predefined projection direction;
a circuit board on which the wireless antenna is mounted; and
a housing that accommodates the wireless antenna, the proximate conductor, and the circuit board, wherein
at least a portion of the housing is formed of a radio-wave-transmissive material, and
within the housing, the proximate conductor is disposed closest to the wireless antenna among conductors other than a conductor mounted on the circuit board.

2. The wireless device according to claim 1, wherein
the predefined direction is a direction perpendicular to the circuit board.

3. The wireless device according to claim 2, wherein
the projection plane of the wireless antenna in the predefined direction is a projection plane with a maximum projected area as compared with projection planes in other directions.

4. The wireless device according to claim 1, wherein
the proximate conductor is plate-shaped, and a planar surface of the proximate conductor faces the circuit board.

5. The wireless device according to claim 1, wherein
the wireless antenna comprises:
an element configured to radiate radio waves; and
a wiring pattern disposed to face the element, wherein
the wiring pattern has a potential corresponding to a reference potential of the circuit board, and
in the circuit board, the proximate conductor is disposed on a side opposite to a side on which the element is disposed.

6. The wireless device according to claim 5, further comprising a wireless IC connected to the wireless antenna, wherein,
in the circuit board, the wireless IC is disposed on a surface opposite to a surface on which the element is disposed, and
the proximate conductor is configured to cover the wireless IC.

7. The wireless device according to claim 1, wherein,
in the predefined direction, an entire projection plane of the wireless antenna overlaps the proximity conductor.

8. The wireless device according to claim 1, wherein
the proximate conductor constitutes a portion of a housing of the wireless device.

9. The wireless device according to claim 1, wherein
a housing of the wireless device is provided with a radio-wave transmission portion that permits radio waves radiated from the wireless antenna to pass through the housing.

10. The wireless device according to claim 9, wherein
the radio-wave transmission portion is provided on a side closer to a communication partner than the wireless antenna in a propagation path of the radio waves, and is provided on a side opposite to the proximate conductor with reference to the wireless antenna.

11. The wireless device according to claim 10, wherein
a width dimension of the radio-wave transmission portion is equal to or greater than one-half of a wavelength of radio waves radiated from the wireless antenna.

12. The wireless device according to claim 10, wherein,
in the predefined direction, on a side of the wireless antenna opposite the proximate conductor, no conductor is present, or, when a conductor is present, a distance between the conductor and the wireless antenna is equal to or greater than one-half of a wavelength of radio waves radiated from the wireless antenna.

13. The wireless device according to claim 12, wherein,
in the predefined direction, a distance between the housing of the wireless device and the wireless antenna is equal to or greater than one-half of a wavelength of radio waves radiated from the wireless antenna.

14. The wireless device according to claim 1, wherein
the wireless antenna comprises:
an element configured to radiate radio waves; and
a wiring pattern disposed to face the element, wherein
the wiring pattern has a potential corresponding to a reference potential of a circuit board on which the wireless antenna is mounted,
the wiring pattern has a comb-teeth shape or a meander shape, and
the projection plane of the wireless antenna includes at least an entirety of a projection plane of the element and an entirety of a projection plane of the wiring pattern.

15. The wireless device according to claim 1, wherein the wireless antenna comprises:
an element configured to radiate radio waves; and
a wiring pattern disposed to face the element, wherein
the wiring pattern has a potential corresponding to a reference potential of a circuit board on which the wireless antenna is mounted,
the element has at least one of a comb shape, an L shape, and a stub shape, and
the projection plane of the wireless antenna includes at least an entirety of a projection plane of the element and an entirety of a projection plane of the wiring pattern.

16. The wireless device according to claim 1, further comprising an insulating sheet between the wireless antenna and the proximate conductor.

17. The wireless device according to claim 1, wherein
a capacitance generated between the proximate conductor and the wireless antenna is larger than a capacitance generated between another conductor and the wireless antenna.
